(19) United States
(12) Patent Application Publication
(10) Pub. No.: US 2021/0332620 A1
(43) Pub. Date: Oct. 28, 2021

(54) DOOR HANDLE ASSEMBLY FOR A VEHICLE DOOR

(71) Applicant: Huf Huelsbeck & Fuerst GmbH & Co. KG, Velbert (DE)

(72) Inventors: Michael Rhein, Moenchengladbach (DE); Bernd Reifenberg, Essen (DE); Jan Heyduck, Sindelfingen (DE); Juergen Jooss, Boeblingen (DE); Martin Lindmayer, Sulz (DE)

(73) Assignee: Huf Huelsbeck & Fuerst GmbH & Co. KG, Velbert (DE)

(21) Appl. No.: 16/479,837

(22) PCT Filed: Dec. 5, 2017
(86) PCT No.: PCT/EP2017/081486

§ 371 Date: Jul. 22, 2019

(30) Foreign Application Priority Data
Jan. 25, 2017 (DE) 102017101421.7

(51) Int. Cl. E05B 85/10; E05B 81/90

(52) U.S. Cl. CPC E05B 85/107; E05B 79/12; E05B 85/103; E05B 81/90

(57) ABSTRACT

A door handle assembly for a vehicle door includes a handle which is mounted on a handle housing and which, in a non-use position, is arranged to extend flush with an outer contour of the vehicle door and is designed to be movable into an actuating position and a vehicle opening lever mounted on the handle housing and movable between a standby position and an unlocking position opening the vehicle door. The handle is movable from the actuating position into an emergency actuating position for manually opening the vehicle door. The handle is decoupled from the vehicle door opening lever when it is in its non-use position and in its actuating position. During movement from the actuating position into the emergency actuating position, the handle is coupled to the vehicle door opening lever and moves the lever into the unlocking position.

The invention relates to a door handle assembly for a vehicle door, wherein the door handle assembly comprises a handle for actuation by an operator to extend flush with an outer contour of the vehicle door in a non-use position and a handle housing attachable to the vehicle door, the handle being mounted to be movable by the operator from the actuating position into an emergency actuating position for manual vehicle door opening.

Door handle assemblies in which the handle in its non-use position to extend flush with the outer contour of the vehicle door are known from the prior art. Thereby, the handle may be designed as an inner or outer handle in the case of these types of door handle assemblies for a vehicle door of a motor vehicle, wherein the present invention relates to a door handle assembly for an outer handle. For such door handle assemblies, there is a plurality of different constructions and embodiments. The design according to the invention of a door handle assembly relates to constructions in which the handle housing is fastened to the rear side of the vehicle door, i.e. the inside of the vehicle. The handle, which is fastened to the handle housing, usually protrudes from the vehicle door in such embodiments and disturbs both the aesthetic impression of the vehicle and its aerodynamics. In order to avoid these disadvantages, there are known prior art door handle assemblies in which the outside of the handle in its non-use position, i.e. in which it is not used, extends approximately flush with the outer contour of the vehicle door, i.e. extends flush. Such a handle can be transferred to an actuating position for opening the vehicle door or an on-board lock, in which the handle protrudes relative to the outer contour of the vehicle door. The handle is moved out using a motor when a legitimate operator approaches the vehicle. Once the handle is no longer needed, it returns to the non-use position and disappears into the vehicle body to avoid producing air resistance. In a currentless emergency operation, the operator can manually move the handle to the actuating position. From the actuating position, a manual actuation of the handle can then mechanically unlock the lock to open the vehicle door. With such known door handle assemblies, the permanent coupling of the handle and a Bowden cable system operatively connected to the vehicle lock represents a safety risk, which is why the installation of prior art mass locks or centrifugal locks is known to prevent unintentional opening of the vehicle door in the event of a vehicle accident. A disadvantage of these well-known door handle assemblies is that the mass lock is an additional part that requires a corresponding installation space and increases the costs of a door handle assembly.

The invention is based on the object to create a solution which provides a door handle assembly in a simple constructive manner, which is cost-effective to manufacture and in which the handle can also be operated to open the vehicle door during a currentless emergency operation while maintaining safety-related requirements.

This object is achieved according to the invention by a door handle assembly for a vehicle door with the features according to claim 1.

The door handle assembly for a vehicle door according to the invention comprises a handle housing attachable to the vehicle door, a handle mounted on the handle housing which in a non-use position is arranged to extend flush with an outer contour of the vehicle door and which is movably formed into an actuating position for actuation, in which the handle protrudes compared to the outer contour of the vehicle door, and a vehicle door opening lever mounted on the handle housing to be movable between a standby position and an unlocking position which opens the vehicle door. The operator can move the handle from the actuating position to an emergency actuating position to open the vehicle door manually. Furthermore, the handle is decoupled from the vehicle door opening lever in its non-use position and in its actuating position, wherein the handle couples with the vehicle door opening lever and moves it to the actuating position during a movement from the actuating position to the emergency actuating position.

Advantageous and practical embodiments and further developments of the invention result from the subclaims.

The invention provides a door handle assembly for a vehicle, which is characterized by a functional construction and comprises a compact and cost-effective structure. In the door handle assembly according to the invention, the operation manually performed by an operator of the door handle assembly on the handle, by which the handle is moved from the actuating position to the emergency actuating position, ensures that only during this movement the handle couples with the vehicle door opening lever and moves it to the unlocking position, in which the vehicle door opening lever unlocks the vehicle lock so that the vehicle door can be opened. This movement is usually carried out during a currentless emergency operation of the door handle assembly, which in normal operation moves the vehicle door lever from the standby position to the unlocking position for motorized unlocking of the vehicle door with the aid of a motor-driven actuator. Because the handle is decoupled by the vehicle door opening lever in its non-use position and in its operating position, the use of a mass lock, to prevent an undesired opening movement of the handle as a result of centrifugal forces acting in the event of a vehicle accident, can be avoided according to the invention. According to the invention, there is only a coupling between the handle and the vehicle door opening lever if the handle is moved from the actuating position to an emergency actuating position.

In order to realize the coupling according to the invention, a lever mechanism is provided to rotate the handle on the handle housing and to couple the handle to the vehicle door opening lever during a movement from the actuating position into the emergency actuating position.

According to the invention, for a stable mounting of the handle on the handle housing, a lever member mounted on the handle housing is connected to a first longitudinal end of the handle, wherein the lever mechanism comprises a passive lever, whose first end is connected in a torque-proof manner to a rotational axis rotatably mounted on the handle housing and whose second end is connected to a second longitudinal end of the handle. According to the invention, the handle is therefore rotatably mounted on the handle housing at its respective longitudinal ends, which is noticeable with an actuation of the handle due to its stable mounting.

A constructively compact option for the realization of the coupling between the handle and vehicle door opening lever is provided in the embodiment of the invention by the fact that the passive lever comprises a radially extending actuating lug at its first end and a hook-shaped cam portion is formed on the vehicle door opening lever, wherein during a movement of the handle from the actuating position in the direction of the emergency actuating position the actuating lug engages in the cam portion and forces the vehicle door opening lever from the standby position into the unlocking position. Upon actuation of the handle, the passive lever is therefore rotated around the rotational axis, whereby the actuating lug arrives into a position in which the actuating lug engages with the cam portion, so that upon another actuation of the handle and rotation of the passive lever, the actuating lug pushes the vehicle door opening lever into the unlocking position.

The invention further provides that a counterforce member is arranged at a longitudinal portion of the passive lever which allows a movement of the handle from the actuating position into the emergency actuating position against a counterforce exerted by the counterforce member. The counterforce makes the handle more difficult for the operator to handle than in normal operation, giving the operator noticeable feedback due to the increasing force, when the handle is moved to an emergency actuating position and initiating an emergency unlocking process.

The invention further provides an extremely compact and reliable assembly, so that the counterforce member is formed as an elastic leg spring member, a first leg of the leg spring member being supported on the actuating lug and a second leg of the leg spring member being in contact with a holding lug formed in a hook-shape. The leg spring member mounted in this manner rotates with the passive lever during normal operation of the door handle assembly.

For an emergency operation, according to an embodiment the invention provides that the second leg of the leg spring member abuts on a limit stop formed on the handle housing during a movement of the handle from the actuating position in the direction of the emergency actuating position, and that the leg spring member is compressed in the emergency actuating position of the handle to generate the counterforce. Consequently, during the movement of the handle, the leg spring member is compressed from the actuating position to the emergency actuating position, generating the counterforce felt by the operator.

It should be understood that the features mentioned above and those still to be explained below may be used not only in the combination indicated but also in other combinations or in a unique position, without leaving the scope of the present invention. The scope of the invention is defined only by the claims.

Other details, features, and advantages of the subject-matter of the invention result from the following description in connection with the drawing, in which exemplary and preferred exemplary embodiments of the invention are presented. In which:

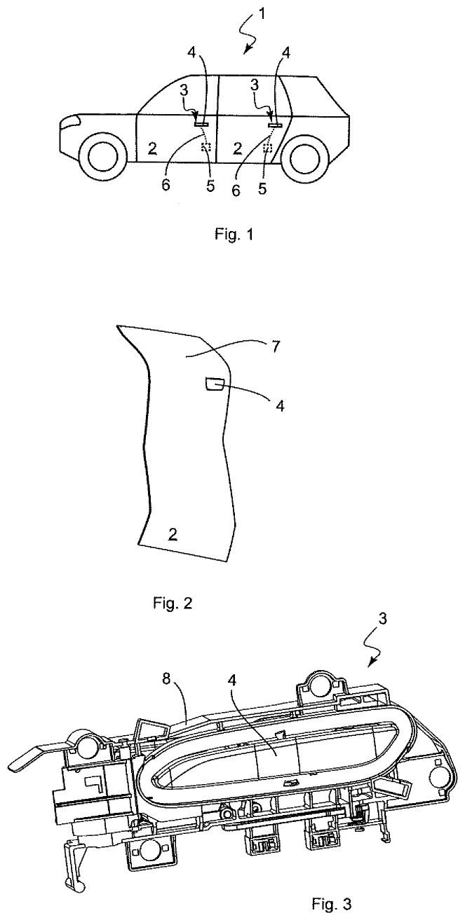

FIG. 1 shows a schematically represented motor vehicle with an exemplarily suggested door handle assembly according to the invention,

FIG. 2 shows a perspective representation of a vehicle door with a handle, which is arranged flush with the door handle assembly according to the invention,

FIG. 3 shows a perspective front view of the door handle assembly according to the invention,

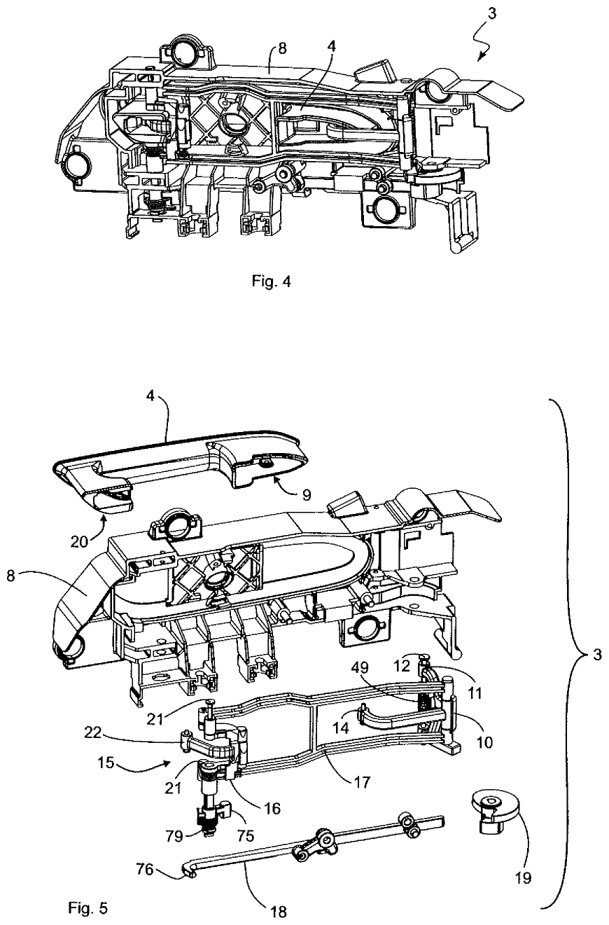

FIG. 4 shows a perspective rear view of the door handle assembly shown in FIG. 3,

FIG. 5 shows a perspective representation of the individual parts of the door handle assembly shown in FIGS. 3 and 4,

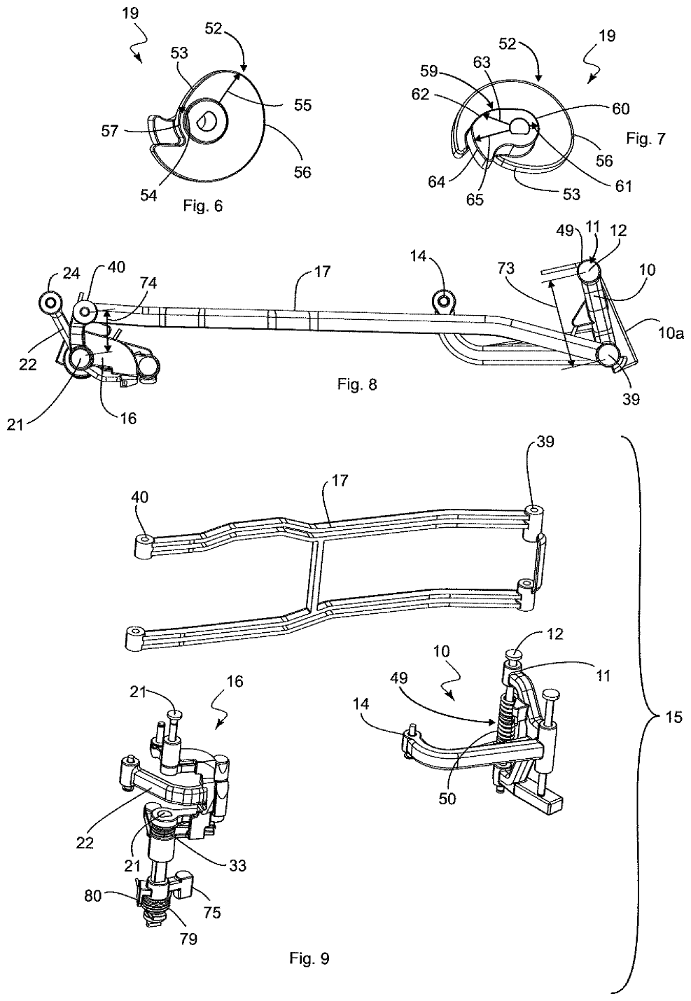

FIG. 6 shows a top view of an positioning member of the door handle assembly,

FIG. 7 shows a bottom view of the positioning member of the door handle assembly shown in FIG. 6,

FIG. 8 shows a top view of a lever system of the door handle assembly,

FIG. 9 shows a perspective representation of the individual parts of the lever system shown in FIG. 8,

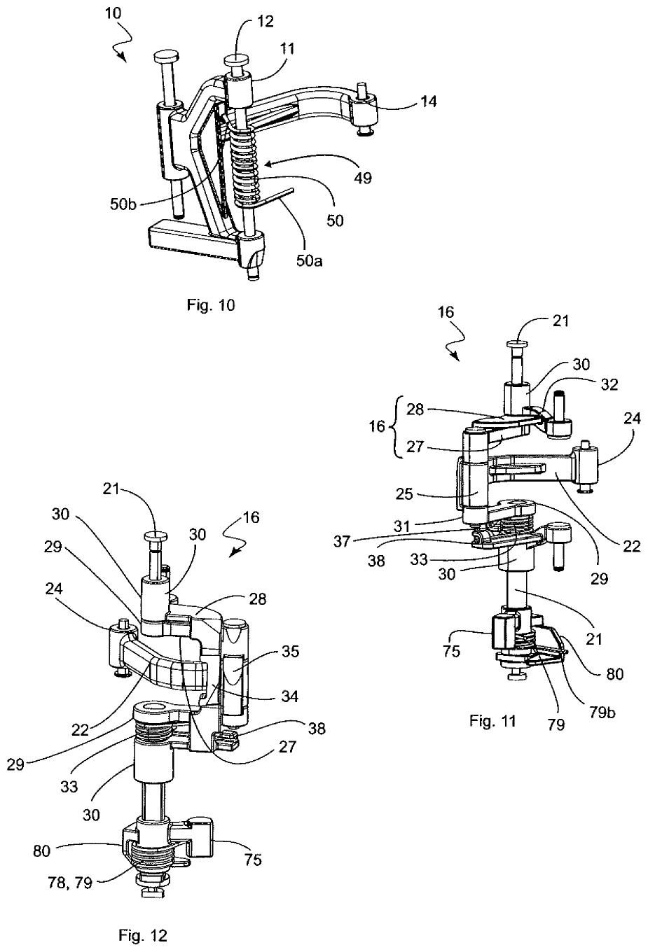

FIG. 10 shows a perspective view of a lever member of the lever system shown in FIG. 8,

FIG. 11 shows a first perspective view of a lever mechanism of the lever system shown in FIG. 8,

FIG. 12 shows a second perspective view of the lever mechanism shown in FIG. 11,

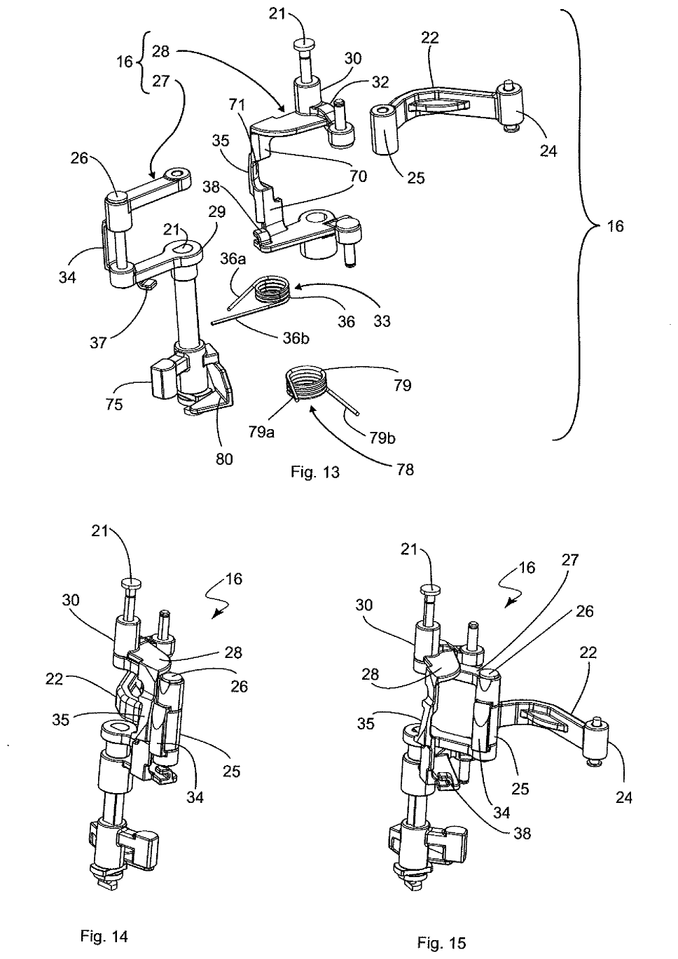

FIG. 13 shows a perspective representation of the individual parts of the lever mechanism shown in FIGS. 11 and 12,

FIG. 14 shows a perspective view of the lever mechanism arranged in a base position shown in FIG. 11,

FIG. 15 shows a perspective view of the lever mechanism arranged in an operating position shown in FIG. 11,

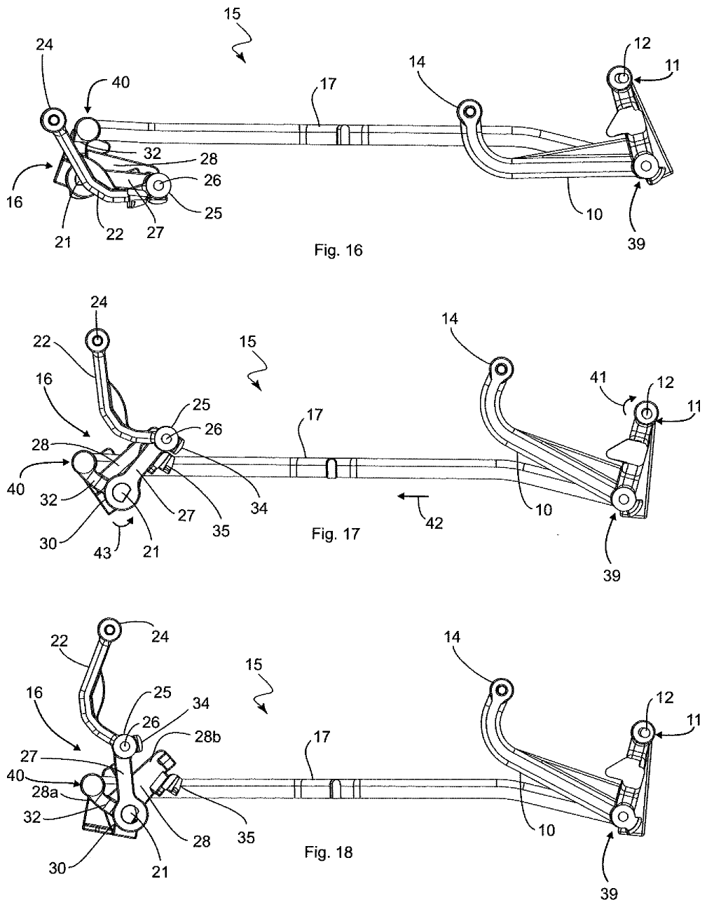

FIG. 16 shows a top view of the lever system of the door handle assembly when the handle is arranged in a non-use position,

FIG. 17 shows a top view of the lever system of the door handle assembly when the handle is arranged in an actuating position,

FIG. 18 shows a top view of the lever system of the door handle assembly when an operator pulls the handle in order to open the vehicle door,

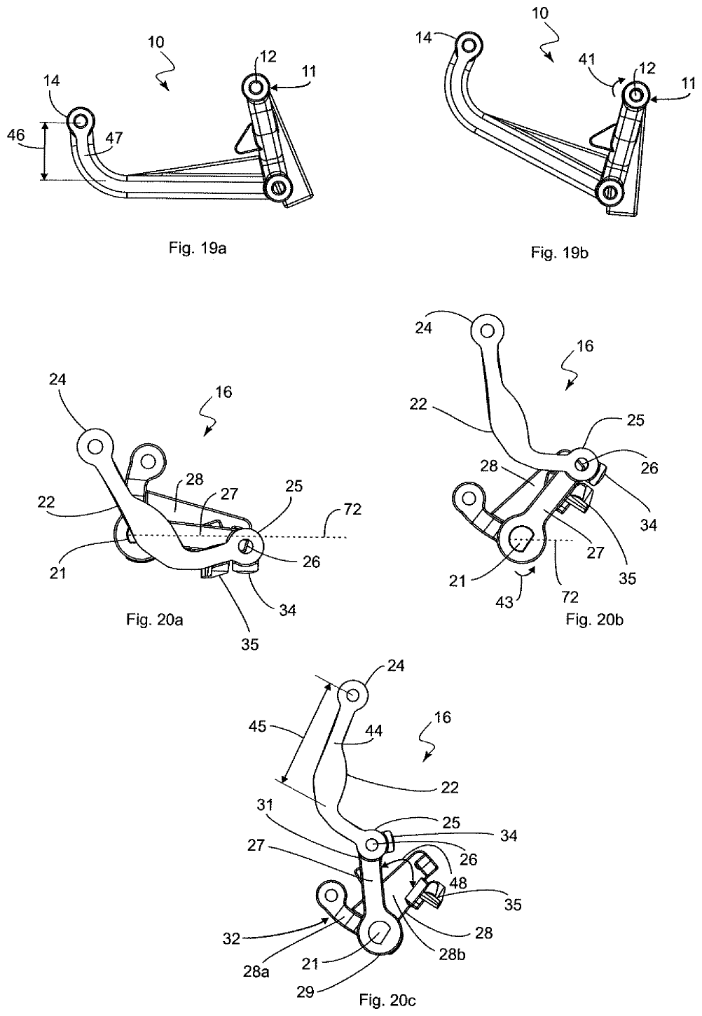

FIG. 19a shows a top view of the lever member shown in FIG. 10 when the handle is arranged in the non-use position,

FIG. 19b shows a top view of the lever member when the handle is arranged in the actuating position,

FIG. 20a shows a top view of the lever mechanism shown in FIG. 11 when the handle is arranged in the non-use position,

FIG. 20b shows a top view of the lever mechanism when the handle is arranged in the actuating position,

FIG. 20c shows a top view of the lever mechanism when an operator pulls the handle in order to open the vehicle door,

FIG. 21 shows a side view of the door handle assembly according to the invention when the handle is arranged in the non-use position,

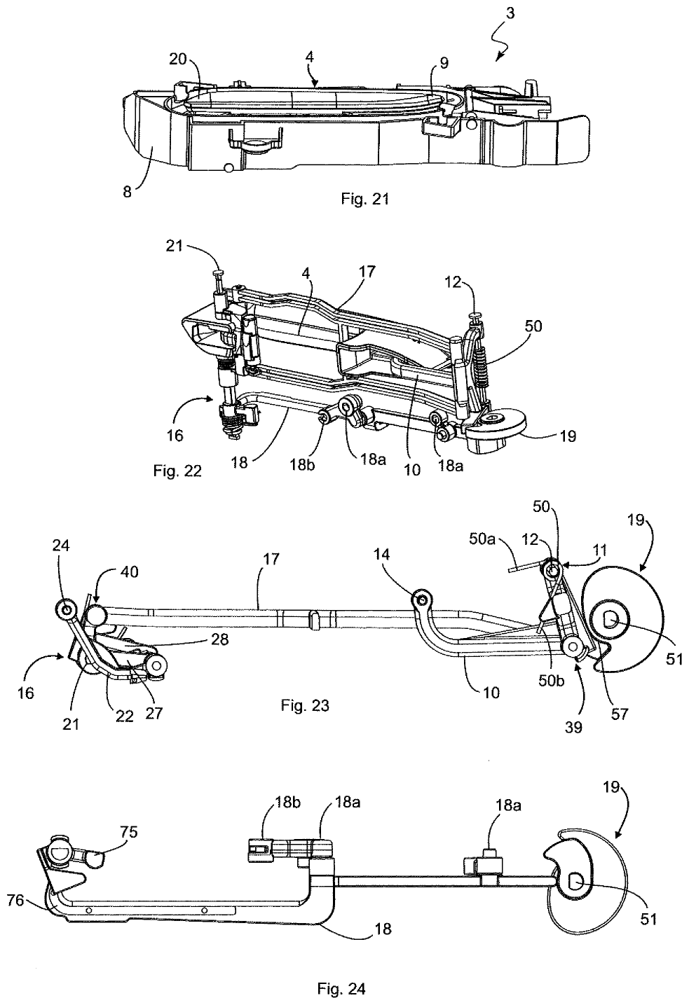

FIG. 22 shows a perspective view of the lever system and a vehicle door opening lever when the handle is arranged in the non-use position,

FIG. 23 shows a top view of the lever system when the handle is arranged in the non-use position,

FIG. 24 shows a bottom view of the lever system when the handle is arranged in the non-use position,

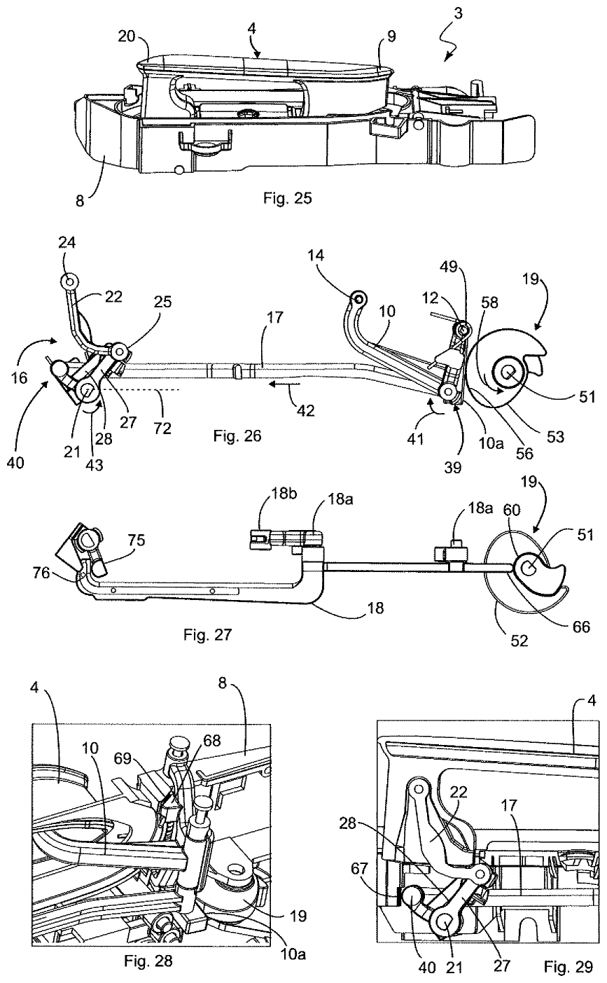

FIG. 25 shows a side view of the door handle assembly according to the invention when the handle is arranged in the actuating position,

FIG. 26 shows a top view of the lever system when the handle is arranged in the actuating position,

FIG. 27 shows a bottom view of the lever system when the handle is arranged in the actuating position,

FIG. 28 shows a detailed view of the lever member when the handle is arranged in the actuating position,

FIG. 29 shows a detailed view of the lever mechanism when the handle is arranged in the actuating position,

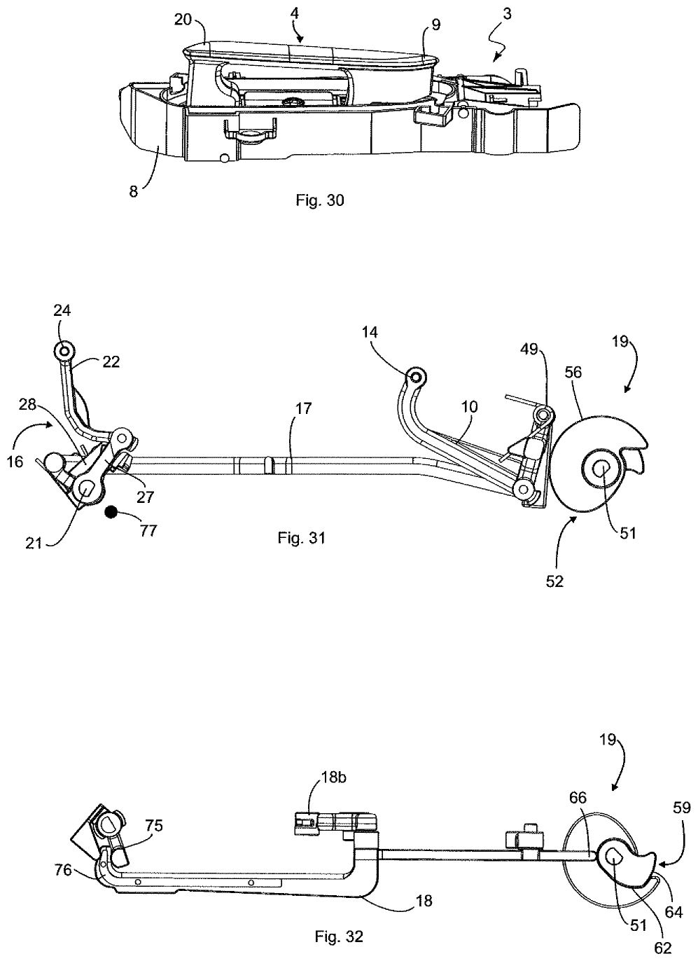

FIG. 30 shows a side view of the door handle assembly according to the invention when the handle is arranged in a servo-opening position,

FIG. 31 shows a top view of the lever system when the handle is arranged in the servo-opening position,

FIG. 32 shows a bottom view of the lever system when the handle is arranged in the servo-opening position,

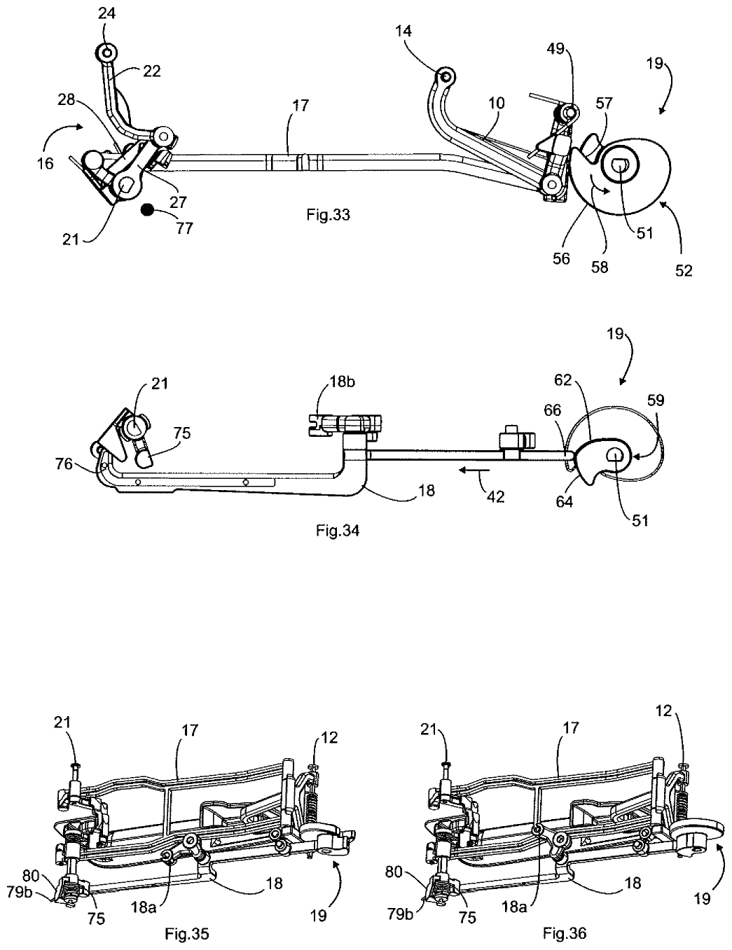

FIG. 33 shows a top view of the lever system when the positioning member is arranged and moved due to the position of the handle in the servo-opening position,

FIG. 34 shows a bottom view of the lever system when the positioning member is arranged and moved due to the position of the handle in the servo-opening position,

FIG. 35 shows a perspective side view of the lever system when the handle is arranged in the servo-opening position,

FIG. 36 shows a perspective side view of the lever system when the positioning member is arranged and moved due to the position of the handle in the servo-opening position,

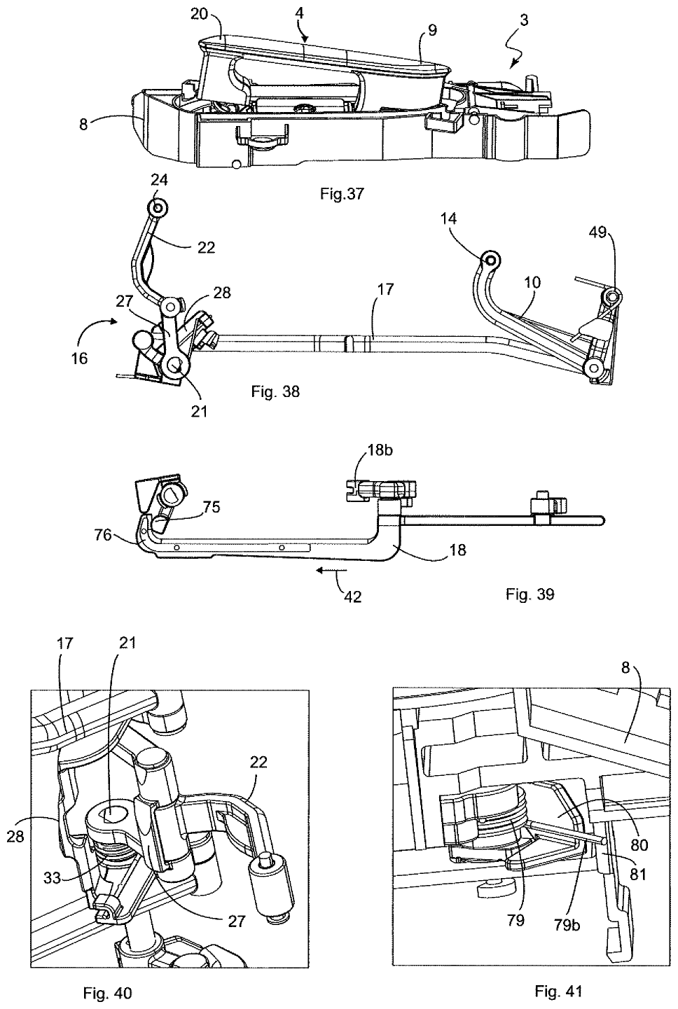

FIG. 37 shows a side view of the door handle assembly when the handle is arranged in an opening position or an emergency actuating position,

FIG. 38 shows a top view of the lever system when the handle is arranged in the opening position or the emergency actuating position,

FIG. 39 shows a bottom view of the lever system when the handle is arranged in the opening position or the emergency actuating position,

FIG. 40 shows a detailed view of the lever mechanism when the handle is arranged in the opening position or the emergency actuating position,

FIG. 41 shows another detailed view of the lever mechanism when the handle is arranged in the opening position or the emergency actuating position,

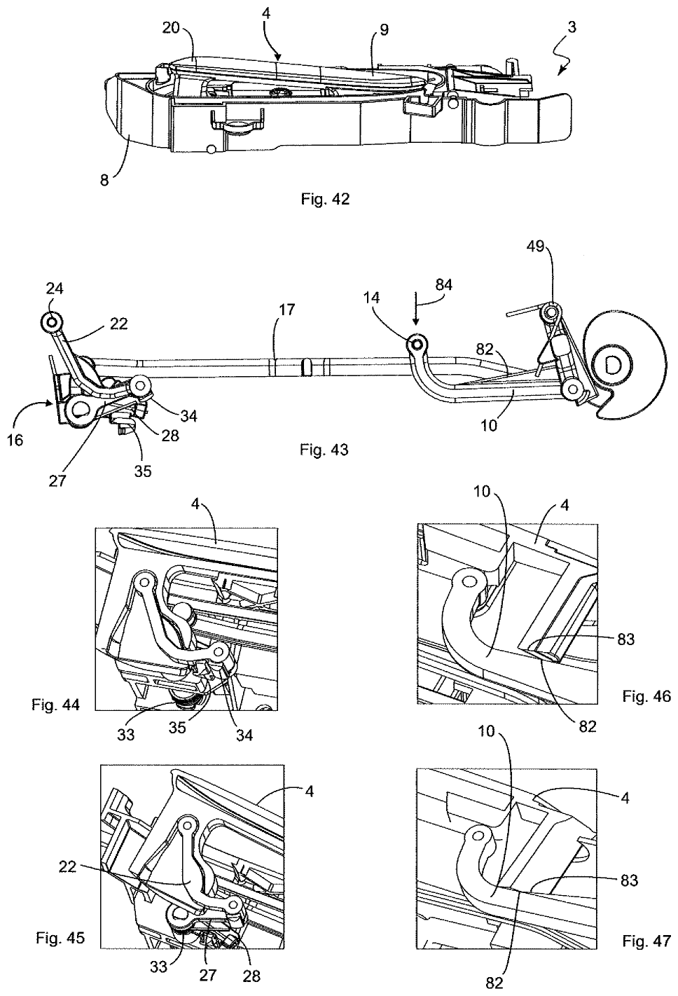

FIG. 42 shows a side view of the door handle assembly according to the invention, when the handle is arranged in an emergency handling position,

FIG. 43 shows a top view of the lever system when the handle is arranged in the emergency handling position,

FIG. 44 shows a detailed view of the lever mechanism when the handle is arranged in the non-use position,

FIG. 45 shows another detailed view of the lever mechanism when the handle is arranged in the emergency handling position,

FIG. 46 shows a detailed view of the lever member when the handle is arranged in the non-use position,

FIG. 47 shows another detailed view of the lever member when the handle is arranged in the emergency handling position,

FIG. 1 shows an example of a vehicle or motor vehicle 1 in the shape of a passenger car, which in the example has four vehicle doors 2 (two of which are shown in FIG. 1) which can be opened by a door handle assembly 3 and in particular with the aid of a door handle or of a handle 4. The vehicle doors 2 are firmly locked via a respective door lock 5, which is formed in the manner of a rotary-latch lock and can only be opened or unlocked from the outside via a respective movement of the handle 4. This movement on the handle 4 consists of a drag movement, wherein the corresponding movement of the handle 4 is transmitted to the corresponding lock 5 via a Bowden cable system 6. The associated vehicle door 2 can be opened with the corresponding movement of the handle 4, wherein a slight drag movement is sufficient for the Bowden cable system 6 to be electrically operated to unlock the door lock 5 in the case of a current-operated normal operation. In the case of a currentless emergency operation, the door handle assembly 3 according to the invention is formed, so that manual unlocking of the door lock 5 and thereby manual opening of the vehicle door 2 is possible by an operator actuating the handle 4.

FIG. 2 shows in perspective view one of the vehicle doors 2 and the handle 4 which serves for opening of the vehicle door 2. In FIG. 2 the handle 4 is arranged approximately flush to the outer contour 7 of the vehicle door 2, i.e. extends flush, when the door handle assembly 3 is installed in the vehicle door 2. In this position, the handle 4 is in a non-use position in which it is not used. From the non-use position shown in FIG. 2, it is possible to transfer the handle 4 to an actuating position in which it protrudes relative to the outer contour 7 of the vehicle door 2. Accordingly, the handle 4 in its actuating position is arranged to protrude from the vehicle door 2. In this protruding actuating position or from the outer contour 7 extended actuating position, an operator can reach behind the handle 4 and operate or handle it to open the vehicle door 2 or to unlock the on-board door lock 5. According to the present invention, the transfer of the handle 4 from the non-use position to the actuating position can occur either in a current-operated normal operation by means of a suitable drive means or in an currentless emergency operation by means of manual actuation by the operator, which is described in detail below. For the current-operated normal operation, proximity sensors or other sensors may be provided to bring the handle 4 from the flush or area-flush mounted non-use position to the actuating position as soon as an operator approaches the door handle assembly 3 or the handle 4.

In FIGS. 3 to 20c the door handle assembly 3 is shown in different views and is shown in detail for certain details. The door handle assembly 3 has a handle housing 8 next to the handle 4, which when installed is fastened to the inside of the vehicle door 2 and serves, among other things, to mount the handle 4 so that the handle 4 in its non-use position is arranged to extend flush with the outer contour 7 of the vehicle door 2 and can be moved into its actuating position for actuation by an operator, wherein the handle 4 protrudes in its actuating position relative to the outer contour 7 of the vehicle door 2 and the operator can reach behind and actuate it for opening the vehicle door 2 in order to unlock the door lock 5 formed in the manner of a rotary-latch lock. FIG. 3 shows the door handle assembly 3 in a perspective front view, wherein the handle 4 is in its non-use position. The rear view of the door handle assembly 3 shown in FIG. 4 illustrates the compact construction of the door handle assembly 3, which requires little installation space. This compact structure is created among other things by a complex lever system 15, which comprises a lever member 10, a lever mechanism 16 and a movement transmission bracket 17, as shown for example in the representation of individual parts in FIG. 5. The lever system 15 is further shown in a top view in FIG. 8 and in a perspective representation of individual parts in FIG. 9. The lever member 10, the lever mechanism 16 and the movement transmission bracket 17 are mounted on the handle housing 8, which is described in detail below. The handle 4 is bound to the handle housing 8 by means of the lever system 15. Further, as shown in FIG. 5 on the basis of the representation of the individual parts, the door handle assembly 3 comprises a vehicle door opening lever 18 and an positioning member 19, which are also each mounted on the handle housing 8.

According to the synopsis of the FIGS. 3 to 47, a first longitudinal end 9 of the handle 4 is connected to the handle housing 8 via the lever member 10. More precisely, a first lever end 11 of the lever member 10 is attached to a lever rotational axis 12, which is rotatably mounted on the handle housing 8, wherein a second lever end 14 of the lever member 10 is rotatably connected to the first longitudinal end 9 of the handle 4. The second lever end 14 of the lever member 10 is accordingly movably coupled to the first longitudinal end 9 of the handle 4 when the lever member 10 rotates around the lever rotational axis 12, which is described more precisely in the following description. For example, as shown in FIGS. 9 and 10, the lever member 10 is formed with a single arm and angled and has a U-shaped form with its angled arm in top view (for example, see FIGS. 16 to 18). A second longitudinal end 20 of the handle 4 is bound to the handle housing 8 via the lever mechanism 16. Thereby, the lever mechanism 16 is rotatably mounted on the handle housing 8 via a rotational axis 21 so that the second longitudinal end 20 of the handle 4 is movably fastened to the handle housing 8 via the lever mechanism 16. As shown, for example, in FIGS. 5, 9, 11 and 12, the rotational axis 21 for the present design example is formed by two portions of the rotational axis, with a handle lever 22 between the two portions of the rotational axis 21.

The lever mechanism 16 is shown in more detail in FIGS. 11 to 15 and comprises the handle 22 and a lever body 23 rotatably mounted on the rotational axis 21. The handle lever 22 is formed single-armed and angled, wherein a first end 24 of the handle lever 22 is rotatably connected with the second longitudinal end 20 of the handle 4. The handle lever 22 is arranged between the two portions of the rotational axis 21, which results in a very compact construction form. A second end 25 of the handle lever 22 is rotatably connected to the lever body 23 via a pivot point 26, as for example shown in FIG. 15. The lever body 23 itself has a passive lever 27 and an active lever 28. A first end 29 of the passive lever 27 and a first end 30 of the active lever 28 are mounted on the rotational axis 21, which is mounted on the handle housing 8 (for example, see FIG. 12). Thereby, the second end 25 of the handle lever 22 is rotatably connected to a second end 31 of the passive lever 27, whereas the first end 29 of the passive lever 27 is connected to the rotational axis 21 in a torque-proof manner for example, see FIG. 11). However, the first end 30 of the active lever 28 is rotatably connected to the rotational axis 21, so that the active lever 28 is rotatably mounted on the rotational axis 21 relative to the same. From the first end 30 of the active lever 28, a lever-arm-shaped connecting web 32 protrudes radially. If the connecting web 32 is regarded as the lever arm of the active lever 28, the active lever 28 can also be regarded as a two-armed lever with a first active lever arm 28a, which corresponds to the connecting web 32, and a second active lever arm 28b (for example, see FIG. 18). What is special about the lever mechanism 16 is the aspect that the passive lever 27 and the active lever 28, which form the lever body 23, perform as a single lever during certain operating processes of the door handle assembly 3 and rotate together around the rotational axis 21, whereas for certain operating conditions of the handle 4 the passive lever 27 and the active lever 28 rotate relative to each other around the rotational axis 21 and perform correspondingly as separate levers. For this purpose, the lever mechanism 16 has a holding member 33, which exerts a holding force on the passive lever 27 and the active lever 28. The holding member 33 is arranged between the first end 29 of the passive lever 27 and the first end 30 of the active lever 28 and is held between the two ends 29, 30 (for example, see FIG. 12). The passive lever 27 has an abutment portion 34, whereas on the active lever 28 a counter abutment portion 35 is formed, as shown for example in FIG. 15. The holding member 33 exerts a holding force on the passive lever 27 and the active lever 28, whereby the abutment portion 34 of the passive lever 27 is pressed against the counter abutment portion 35 of the active lever 28. When a force greater than the holding force of the holding member 33 is acting on the lever body 23 consisting of the passive lever 27 and the active lever 28, then the passive lever 27 can be rotated relative to the active lever 28 around the rotational axis 21, otherwise the passive lever 27 and the active lever 28 form a combined lever and rotate together around the rotational axis 21. Consequently, the holding member 33 allows the passive lever 27 to move relative to the active lever 28 against the holding force exerted by the holding member 3 so that the abutment portion 34 of the passive lever 27 is arranged spaced-apart from the counter abutment portion 35 of the active lever 28. In the design example shown in the figures, the holding member 33 is formed as an elastic spring member 36, wherein a first leg 36a of the spring member 36 engages in a hook-shaped holding lug 37 formed on the passive lever 27 and a second leg 36b of the spring member 36 engages in a hook-shaped holding piece 38 formed on the active lever 28, as can be seen for example from the FIGS. 11 to 15. The spring member 36 is configured wound around a portion of the rotational axis 21, as shown in FIGS. 11 and 12. FIG. 14 shows a position of the passive lever 27 and the active lever 28 in which the abutment portion 34 of the passive lever 27 abuts on the counter abutment portion 35 of the active lever 28, whereas FIG. 15 shows a different position in which the abutment portion 34 of the passive lever 27 is arranged spaced-apart from the counter abutment portion 35 of the active lever 28, which shows that the passive lever 27 and the active lever 28 are rotatably mounted relative to each other.

The FIGS. 16 to 18 show different assemblies of the individual parts of the lever system 15 depending on the position of the handle, wherein for reasons of clarity only the parts of the lever system 15 are shown in a top view and the other parts of the door handle assembly 3 are omitted. The FIGS. 19a to 20c further show different assemblies of the lever member 10 and the lever mechanism 16. The FIGS. 16, 19a and 20a show assemblies in which the handle is arranged in a non-use position to extend extending flush with the outer contour 7. In the FIGS. 17, 19b and 20b, however, the handle 4 is arranged in an actuating position, in which the handle 4 is arranged exposed relative to the outer contour 7 of the vehicle door 2. In the FIGS. 18 and 20c the handle 4 is then shown in each case in a position in which an operator pulls the handle 4 for opening the vehicle door 2. FIGS. 16 to 18, among other Figures, show that the lever member 10 is connected to the lever mechanism 16 in a movably coupled manner via the movement transmission bracket 17. Thereby, a first longitudinal end 39 of the movement transmission bracket 17 is rotatably connected to the lever member 10 at a distance or spaced apart from the lever rotational axis 12. A second longitudinal end 40 of the movement transmission bracket 17 is also rotatably connected to the lever mechanism 16 at a distance or spaced apart from the rotational axis 21. More precisely, the second longitudinal end 40 of the movement transmission bracket 17 is rotatably connected to the free end of the connecting web 32 or to the first active lever arm 28a of the active lever 28. The first longitudinal end 39 of the movement transmission bracket 17 is rotatably connected to the lever member 10 with a lever rotational axis distance 73 from the lever rotational axis 12, whereas the second longitudinal end 40 of the movement transmission bracket 17 is rotatably connected to the lever mechanism 16 with a lever rotational axis distance 74 from the lever rotational axis 21 (for example, see FIG. 8), wherein the lever rotational axis distance 73 has a greater length than the rotational axis distance 74. When the handle 4 is moved from its non-use position shown in FIGS. 16, 19a and 20a to the actuating position shown in FIGS. 17, 19b and 20b, then the lever member 10 rotates clockwise according to the arrow 41 around the lever rotational axis 12, following which the movement transmission bracket 17 hingedly connected to the lever member 10 moves in the direction of the lever mechanism 16 or in the direction of the second longitudinal end 20 of the handle 4 (see arrow 42 in FIG. 17) around the lever rotational axis 12. Further, the second lever end 14 of the lever member 10, to which the first longitudinal end 9 of the handle 4 is hingedly mounted around the lever rotational axis 12, whereby the handle 4 is moved from its flush non-use position into the actuating position and protrudes from the outer contour 7 of the vehicle door 2, so that an operator can reach behind the handle 4 for actuation. The movement of the movement transmission bracket 17 in the direction of the lever mechanism 16 or in the direction of the second longitudinal end 20 of the handle 4 (see arrow 42 in FIG. 17) effects that the lever mechanism 16 rotates counterclockwise around the rotational axis 21 (see arrow 43 in FIG. 17). This rotational movement is effected by the movement transmission bracket 17, whose second longitudinal end 40 is movably and hingedly connected to the connecting web 32 or the first active lever arm 28a of the active lever 28. During this rotational movement of the lever mechanism 16, the holding force of the holding member 33 is sufficient enough so that the holding member 33 presses the abutment portion 34 of the single-arm formed passive lever 27 against the counter abutment portion 35 of the active lever 28. However, during this rotational movement of the lever mechanism 16 the handle lever 22 swivels out, which is hingedly connected with its first end 24 to the handle 4 and which is hingedly connected with its second end 25 to the second end 31 of the passive lever 27. The swiveling out movement of the lever 22 causes also the second longitudinal end 20 of the handle 4 to be exposed from the outer contour 7 of the vehicle door 2. During the movement of the handle 4 from the non-use position into the actuating position, the handle 4 is first moved out at its first longitudinal end 9 and then the handle 4 is moved out at its second longitudinal end 20 from the outer contour 7 of the vehicle door 2 due to shorter lever lengths of the lever member 10 relative to the lever length of the lever mechanism 16, wherein the handle 4 is moved out at its first longitudinal end 9 less far than at its second longitudinal end 20 from the outer contour 7. To be more precise, during a movement from the non-use position into the actuating position, the handle 4 is exposed at its first longitudinal end 9 by approx. 28 mm and at its second longitudinal end 20 by approx. 44 mm, whereby the handle 4 in its actuating position is not arranged parallel to, but at an angle to, the outer contour 7 of the vehicle door 2. The angled assembly of the handle 4 in its actuating position is made possible among other things by the fact that a handle lever leg 44 ending at the first end 24 of the handle lever 22 is formed with a handle lever length 45 which is at least 1.25 times greater than a lever member length 46 of a lever member leg 47 ending at the second lever end 14 of the lever member 10 (for example, see FIGS. 19a and 20c). When the handle 4 is actuated by an operator from the actuating position then this is a drag movement on the handle 4, causing it to reach the position shown in FIGS. 18 and 20c. In this position, the lever member 10 remains arranged in the position in which it had already arrived in the actuating position. Consequently, there is no additional rotation around the lever rotational axis 12. Instead, a relative movement occurs at the lever mechanism 16 between the passive lever 27 and the active lever 28, wherein the operator must apply a force to the handle 4 during his drag movement which is greater than the holding force of the holding member 33. If this is the case, the operator's force effected on the handle 4 moves the passive lever 27 relative to the active lever 28, wherein the active lever 28 remains in the position it has already occupied in the actuating position of the handle. As shown in FIGS. 18 and 20c, the abutment portion 34 of the passive lever 27 is arranged spaced-apart from the counter abutment portion 35 of the active lever 28, as shown by arrow 48 in FIG. 20c. The passive lever 27 therefore occupies an extended position pointing to the handle 4 relative to its configuration in the actuating position of the handle, in which the second longitudinal end 20 of handle 4 protrudes even more from the outer contour 7 of vehicle door 2. To be more precise, in FIG. 20c, the passive lever 27 and the handle lever 22 occupy respective positions, which present a maximum extension of these two levers 22, 27, because both levers 22, 27 are arranged aligned transversely to the handle housing 8 or to the movement transmission bracket 17, so that this assembly realizes a maximum deflection of the second longitudinal end 20 of the handle 4. Therefore, it is characteristic for the lever system 15 of the door handle assembly 3 according to the invention that during a movement of the handle 4, the second lever end 14 of the lever member 10 is arranged at a constant spacing from the lever rotational axis 12, whereas the first end 24 of the handle lever 22 is arranged at a varying spacing from the rotational axis 21 depending on the movement position of the handle 4.

The operation of the door handle assembly 3 according to the invention and other technical features of the invention are described below.

In FIGS. 21 to 24 the handle 4 of the door handle assembly 4 is arranged in its non-use position, in which the handle 4 is arranged to extend flush with the outer contour 7 of the vehicle door 2. In other words, the handle 4 in its non-use position is positioned area-flush mounted in a door panel representing the outer contour 7. A mechanical restoring member 49 pushes the handle 4 into its non-use position and holds it in this position as shown in FIG. 21, wherein the mechanical restoring member 49 allows a movement of the handle 4 from the non-use position towards the actuating position against a restoring force produced by the mechanical restoring member 49. In the design example shown, the mechanical restoring member 49 is formed as a restoring spring 50 which is wound around the lever rotational axis 12 (for example, see FIGS. 9 and 10). Thereby, a first spring leg 50a of the restoring spring 50 is supported on the handle housing 8, whereas a second spring leg 50b of the restoring spring 50 is supported on the lever member 10. The handle 4 is therefore pressed by means of the restoring spring 50 into the non-use position against the seals and end stops not shown in the figures. However, an injury of the operator's hand is not possible when the handle 4 is held, since the restoring force of the restoring spring 50 is not dimensioned so strongly that a serious jamming of the operator's hand would be possible. The synopsis of the FIGS. 22 to 24 shows some of the many specificities of the door handle assembly 3 according to the invention on the basis of the non-use position of the handle 4. In FIG. 22, the handle housing 8 is omitted for more clarity. As shown in FIG. 22, the lever member 10 is movably connected with the lever mechanism 16 via the movement transmission bracket 17, so that a rotation of the lever member 10 around the lever rotational axis 12 causes a rotation of the lever mechanism 16 around the rotational axis 21. The vehicle door opening lever 18, which is formed bar-shaped, is mounted on the handle housing 8 so as to be movable parallel to the movement transmission bracket 17 via two hinge points 18a, wherein a Bowden cable lever 18b protrudes radially from one of the two hinge points 18a, to which a Bowden cable is fastened, which again is connected to the door lock 5 of the vehicle door 2 and serves in a known manner to unlock the door lock 5. According to the invention, the lever member 10 and the lever mechanism 16 are disengaged from the movement transmission bracket 17 when the handle 4 is in the non-use position. Meaning, in the non-use position of the handle 4, the lever member 10 and the lever mechanism 16 are decoupled from the movement transmission bracket 17, whereby the invention differs from the known prior art, where there is a durable and permanent connection between the handle and the Bowden cable for all positions of the handle. In the non-use position of the handle 4, the movement transmission bracket 17 is arranged in a standby position (for example, see FIG. 22) from which it can be moved into an unlocking position in order to unlock the door lock 5, which is formed in the manner of a rotary-latch lock. Another special feature of the invention, apart from the decoupling of the Bowden cable lever 18 from the handle 4 in its non-use position, is that also in the non-use position of the handle 4, a motor-driven positioning member 19 has no firm connection to the lever member 10 and the lever mechanism 16. In other words, the motor-driven positioning member 19 is decoupled from the lever member 10 and the lever mechanism 16 when the handle 4 is in the non-use position and has no firm connection to the lever member 10 and the lever mechanism 16. The positioning member 19 therefore does not engage with the lever member 10 and with the lever mechanism 17 when the handle 4 is in its non-use position. The motor-driven positioning member 19 is mounted on the handle housing, wherein a motor drive axis 51 of an electric motor drives and rotates the positioning member 19. According to the invention, when the handle 4 is in the non-use position, both the movement transmission bracket 17 used to unlock the door lock 5 and the positioning member 19 are decoupled from the lever member 10 and the lever mechanism 16. In the non-use position of the handle 4, the positioning member 19 occupies a resting position shown in FIGS. 23 and 24.

With respect to FIGS. 25 to 29, different views are shown for a current-operated normal operation of the door handle assembly 3 according to invention. In a current-operated normal operation of the door handle assembly 3, an approximation of an authorized operator to the vehicle 1 is recognized in a known manner by a vehicle controlling unit, whereupon a signal is sent from the vehicle controlling unit to the electromotor, which then starts its operation and rotates the positioning member 19 via the motor drive axis 51. The electromotor is energized for a predetermined period of time and rotates the positioning member 19 around the motor drive axis 51 by an angle in a range from 90° to 130°. The positioning member 19 moves from its resting position into a handle extension position shown in FIGS. 26 and 27. The positioning member 19 is thereby rotatably mounted on the handle housing via the motor drive axis 51. As shown in FIGS. 26 and 27 in synopsis with FIGS. 6 and 7, the motor-driven positioning member 19 is discoidal with a non-uniform edge 52. When the positioning member 19 is rotated around the motor drive axis 51, in which the positioning member 19 is rotated from its resting position to its handle extension position, the non-uniform edge 52 interacts with a lever lug 10a formed on the lever member 10. The non-uniform edge 52 has a first edge portion 53 with a radius increasing from a minimum radius 54 to a maximum radius 55 and a second edge portion 56 with a maximum radius 55. Especially in FIGS. 6 and 26 it can be recognized that the maximum radius 55 is larger than the minimum radius 54. The non-uniform edge 52 further has a third edge portion 57 with the minimum radius, wherein the third edge portion 57 is formed in front of the first edge portion 53 and the second edge portion 56 extends between the first edge portion 53 and the third edge portion 58. Thereby, the transition from the second edge portion 56 to the third edge portion 57 is formed abruptly. In the current-operated normal operation, the motor-driven positioning member 19 rotates the lever member 10 counterclockwise from its resting position around the lever rotational axis 12, as shown by the arrow 58 in FIG. 26, wherein the rotation is a uniform handle-exposition rotational movement of the motor-driven positioning member 19. During this uniform handle-exposition rotational movement of the motor-driven positioning member 19 from the resting position into the handle extension position, the first edge portion 53 presses with increasing radius against the lever lug 10a of the lever member 10 and consequently moves the handle 4 via the lever member 10 from the non-use position into its actuating position shown in FIG. 25, in which the handle 4 protrudes relative to the outer contour 7 of the vehicle door 2. The uniform handle-exposition rotational movement of the motor-driven positioning member 19 stops when the second edge portion 56 of the motor-driven positioning member 19 abuts against the lever lug 10a of the lever member 10. The motor drive axis 51 rotates the positioning member 19 by means of the uniform handle-exposition rotational movement at an angle in a range from 90° to 130°, which ensures that the lever lug 10a abuts against the second edge portion 56, so that the first longitudinal end 9 of the handle 4 is arranged in an exposed position relative to the outer contour 7 of the vehicle door 2. It should be noted that the lever lug 10a of the lever member 10 abuts on the third edge portion 57 when the handle 4 is in the non-use position and the motor-driven positioning member 19 is in the resting position, as shown in FIG. 23. Referring to FIGS. 25 to 29, it is to be noted that the vehicle opening lever 18, arranged in the actuating position of the handle 4, is still arranged in the standby position in which the Bowden cable lever 18b does not unlock the door lock 2. The reason for this is an unlocking contour 59, which is formed on one of the two side surfaces (upper side or lower side) of the positioning member 19, discoidal formed and motor-driven. The unlocking contour 59 interacts with the vehicle door opening lever 18 during a movement of the positioning member 19 from the handle extension position into the door opening position. As shown in FIG. 7, the unlocking contour 59 has a first contour portion 60 with a constant neutral radius 61, a second contour portion 62 with a progression radius 63 and a third contour portion 64 with a constant radius 65. The constant radius 65 is larger than the neutral radius 61, wherein the constant radius 65 and the neutral radius 61 each have a constant radius. Further, the progression radius 63 is a radius that increases from the neutral radius 61 to the constant radius 65. As shown in FIGS. 26 and 27 in synopsis with FIGS. 6 and 7, the constant radius 65 of the unlocking contour 59 is smaller than the maximum radius 55 of the non-uniform edge 52 of the motor-driven positioning member 19. As an alternative to the unlocking contour formed on the positioning member 19, it is also conceivable that a curved disc, additionally to and separately from the motor-driven positioning member 19, is mounted rotatably on the handle housing 8 via the motor drive axis 51, wherein the curved disc interacts with the vehicle door opening lever 18 in order to move the vehicle door opening lever 18 from the standby position into an unlocking position, wherein the unlocking position is mentioned below. In the current-operated normal operation of the door handle assembly, the first contour portion 60 with neutral radius 61 tangentially moves past a longitudinal end 66 of the vehicle door opening lever 18 (see FIG. 27) during a rotational movement of the motor-driven positioning member 19 when it rotates from the resting position into the handle-extension position, so that the vehicle opening lever 18 remains in the standby position. The uniform handle-exposition rotational movement of the positioning member 19 causes, as stated above—a rotation of the lever member 10 around the lever rotational axis 12, whereby, firstly, the handle 4 is exposed at its first longitudinal end 9 and, secondly, the movement transmission bracket 17, which is movably coupled and rotatably connected with its first longitudinal end 39 to the lever member 10, is moved in the direction of the lever mechanism 16 (see arrow 67). Further, at the end of the uniform handle-exposition rotational movement of the positioning member 19, the second longitudinal end 40 of the movement transmission bracket 17 abuts on the handle housing 8. Consequently, the positioning member 19 presses the second longitudinal end 40 of the movement transmission lever 17 at least in portions against an arresting stop 67 fastened to the handle housing 8 (see FIG. 29), so that the movement transmission lever 17 with its second longitudinal end 40 is secured and abutted against the handle housing 8 in a wobble-free and tilt-free manner. Further, the motor-driven positioning member 19 presses a support lug 68 formed on the lever member 10 at least in portions against a support stop 69 formed on the handle housing 8 (see FIG. 28), so that the movement transmission lever 17 with its first longitudinal end 39 is also secured and abutted against the handle housing 8 in a wobble-free and tilt-free manner. Due to the movement of the movement transmission bracket 17 parallel to the handle housing 8 as a result of the clockwise rotation of the lever member 10 around the lever rotational axis (see arrow 41), the movement transmission bracket 17 rotates the lever mechanism 16 counterclockwise around the rotational axis 21 (see arrow 43), as already described for FIG. 17, to which reference is made here to avoid repetitions. The movement transmission bracket 17 interacts with the active lever 28 and rotates the active lever 28 around the rotational axis 21. Thereby, the passive lever 27 and the active lever 28 turn as the combined lever body 23 around the rotational axis 21, because the holding force of the holding member 33 presses the abutment portion 34 of the passive lever 27 against the counter abutment portion 35 of the active lever 28, wherein the passive lever 27 abuts during this rotational movement on support surfaces 70 (for example, see FIG. 13), which abut on the passive lever 27 during the rotational movement, so that the active lever 28 rotates together with the passive lever 27 when the positioning member 19 rotates from its resting position into the handle-extension position. The force transmitted to the lever mechanism 16 by the movement of the movement transmission bracket 17 causes the handle lever 22 to occupy the position shown in FIGS. 26 and 29. The first end 24 of the handle 22 cannot move differently due to its coupling with the handle 4 and moves away from the rotational axis 21, whereby the second longitudinal end 20 of the handle 4 is also arranged exposed out of the outer contour 7 of the vehicle door 2 when the positioning member 19 is arranged in the handle-extension position. The binding of the second longitudinal end 20 of the handle 4 is therefore constructed in the manner of a toggle lever, wherein the active lever 28 and the passive lever 27 are held stably in their abutting position against one another at least in the non-use position of the handle 4 by the holding force of the holding member 33, and wherein during the movement of the handle 4 into its actuating position the supporting surfaces 70 of the active lever 28 also move the passive lever 27 when the lever mechanism 16 rotates around the rotational axis 21. As a result of the different length designs of the handle lever length 45 of the handle lever 22 and the lever member length 46 of the lever member 10, the first longitudinal end 20 of the handle 4 is exposed from the outer contour 7 of the vehicle door 2 to the second longitudinal end 20 of the handle 4 when the handle 10 is exposed from its non-use position into its actuating position in the current-operated normal operation. This time-delayed extension movement of the two longitudinal ends 9 and 20 of the handle creates a better break-away of the handle 4 in case of icing. The time delay is thereby generated as follows. The active lever 28 of the lever body 23 has a supporting member 71 (for example, see FIG. 13), on which the handle lever 22 abuts at least in portions in the non-use position of the handle 4 and when the handle 4 moves in the direction of its actuating position until a dead point 72 is exceeded. Only when the second end 25 of the handle lever 22 has exceeded the dead point 72, the handle lever 22 will raise from the supporting member 71 and move out the second end 20 of the handle 4. This means that the lever member 10 moves out the first longitudinal end 9 of the handle 4 from the outer contour 7 using rotation around the lever rotational axis 12 and the lever mechanism 16 moves out the second longitudinal end 20 from the outer contour 7 using rotation around the rotational axis 21 only after the dead point 72 of the handle lever 22 has been exceeded, although the lever member 10 is movably connected to the lever mechanism 16 so that, when the handle 4 is moved from the non-use position into the actuating position, the lever member 10 rotates around the lever rotational axis 12 and at the same time the lever mechanism 16 rotates around the rotational axis 21. Further, the handle 4 is not only swiveled out vertically to the handle housing 8, but also transversely to this direction, which supports the better break-away. In normal operation by the positioning member 19 until the movement transmission bracket 17 abuts on the arresting stop 67 and the support lug 68 abuts on the support stop 69. As a result, the movement transmission bracket 17 is held in position between the positioning member 19 and the arresting stop 67 in a wobble-free manner. Due to the different lever lengths, the handle 4 moves out approx. 28 mm at its first longitudinal end 9 and approx. 40 mm at its second longitudinal end 20, so that the handle 4 in its actuating position is arranged diagonally to the outer contour 7 and to the handle housing 8. Because of the compact lever system 15 and its compact lever movement when the handle 4 is moved out, installation space can be saved in critical areas such as the window guide of the vehicle door 2. It is characteristic for the door handle assembly 3 that during a movement of the handle 4, the second lever end 14 of the lever member 10 is arranged at a constant spacing from the lever rotational axis 12, whereas the first end 24 of the handle lever 22 is arranged at a varying spacing from the rotational axis 21 depending on the movement position of the handle 4. For the operation of the door handle assembly 3 with the handle 4 bound to the handle housing 8 via the lever member 10 and the lever mechanism 16, it is characteristic, among other things, that during the movement from the non-use position into the actuating position the first longitudinal end 9 of the handle 4 is moving out from the lever member 10 out of the outer contour 7 of the vehicle door 2 and the second longitudinal end 20 of the handle 4 is moving out from the lever mechanism 16 with a time delay to the first longitudinal end 9 of the handle 4, wherein the second longitudinal end 20 of the handle 4 is moved out further from the lever mechanism 16 than the first longitudinal end 9 of the handle 4 and wherein the first longitudinal end 9 of the handle 4 is moved out at a time prior to the second longitudinal end 20 of the handle 4. During the movement of the handle 4 from its non-use position to the actuating position, the lever mechanism 16 is rotated around the rotational axis 21 until an actuating lug 75 extending radially from the first end 29 of the passive lever 27 almost engages with a hook-shaped cam portion 76 formed on the vehicle door opening lever 18 as shown in FIG. 27. Contrary to the embodiment described above, in the design example shown, the actuating lug 75 is formed as a separate part which is connected to the rotational axis 21 in a torque-proof manner. When the handle 4 is arranged in the actuating position and the lever mechanism 16 has occupied its corresponding position, a small gap remains between the actuating lug 75 and the cam portion 76.

This small gap between the actuating lug 75 and the cam portion 76 is necessary so that a slight pull on the handle 4 by an operator does not cause the door lock 5 to open mechanically. This is because a slight pull on the handle 4 should have the effect of servo-unlocking the door lock 5. The servo-unlocking effected by the operator should therefore be possible with a reduced force by the operator compared to a purely mechanical unlocking. The servo-unlocking therefore supports the operator during unlocking, whereby the pulling force applied by the operator is detected and the actual unlocking process occurs by the drive motor. The FIGS. 30 to 36 show assemblies of the individual parts of the door handle assembly 3 when the handle 4 is moved from the actuating position into a servo-opening position by an operator. The actuation of the operator is thereby a drag movement on the handle 4, wherein in FIGS. 30 to 36 the handle 4 is arranged in the servo-opening position for a current-operated normal operation of the door handle assembly 3. During the servo-actuation by the operator, the handle 4, which is arranged in its actuating position, is pulled. Since the handle 4 in its actuating position cannot be moved any further at its first longitudinal end 9, the drag movement by an operator causes the handle 4 at its second longitudinal end 20 to be pulled further outwards relative to the outer contour 7 and the lever mechanism 16 rotates about 3° around the rotational axis 21, whereby the handle 4 is arranged in the servo-opening position shown in FIG. 30. This rotational movement by the operator, which is transmitted to the passive lever 27 via the handle lever 22, occurs against the holding force of the holding member 33. Thereby, the rotation of the passive lever 27 caused by the operator is effected against a counterforce exerted by a counterforce member 78. The operator therefore experiences an increase in force when the handle 4 is servo-actuated, which is equivalent to a stop lug that can be felt by the operator, so that he will no longer attempt to pull out the handle 4 any further. The counterforce member 78 (for example, see FIGS. 35 and 36) can be arranged on a longitudinal portion of the passive lever 27. In the design example shown, the counterforce member 78 is arranged on the actuating lug 75 and is designed as an elastic leg spring member 79, wherein a first leg 79a of the leg spring member 79 is supported on the actuating lug 75 and a second leg 79b of the leg spring member 79 abuts against a hook-shaped holding lug 80 which protrudes radially from the actuating lug 75. The second leg 79b of the leg spring member 79 comes into abutment with a limit stop 81 formed on the handle housing 8 (see, for example, FIG. 41) during the movement of the handle 4 from the actuating position into the servo-opening position, so that the leg spring member 79 is compressed in the servo-actuating position of the handle 4 to produce the counterforce. The rotation or oscillation of the passive lever 27, which is torque-proof connected to the rotational axis 21, is detected by detection means 77 arranged on the handle housing 8. The detection means 77 is only exemplarily indicated in FIGS. 31 and 33 and can be a Hall sensor, whereby a movement of the handle 4 from the actuating position into the servo-opening position can easily be detected or captured in order to send a corresponding signal to the vehicle controlling unit or directly to the drive motor, wherein the drive motor then moves the positioning member 19 from its handle-extension position (see FIGS. 31, 32 and 35) into a door-opening position (see FIGS. 33, 34 and 36), thereby moving the vehicle door opening lever 18 is then moved by the positioning member 19 from its standby position into an unlocking position in which the vehicle door 2 can be opened. However, other sensors or detection means are also conceivable in order to detect a movement of the handle 4 and to activate a drive motor for moving the actuating means 19. The motor-driven positioning member 19, which is movably coupled to the lever member 10, is therefore mounted on the handle housing 8 so that it can move from the resting position via the handle-extension position into the door opening position. The detection means 77 is formed in such a manner that it effects a movement of the motor-driven positioning member 19 from the handle-extension position into the door-opening position upon detection of a movement of the handle 4 from the actuating position into the servo-opening position. While FIGS. 31 and 33 show a top view of the individual levers and the positioning member 19 of the door handle assembly 3, FIGS. 32 and 34 show a bottom view of the positioning member 19, the actuating lug 75, which is torque-proof bound to the rotational axis 21, and the vehicle door opening lever 18. The motor-driven positioning member 19 is coupled to the vehicle door opening lever 18 mounted on the handle housing 8 to be movable between the standby position and the unlocking position. When the motor-driven positioning member 19 moves from the handle-extension position (for example, see FIG. 31) into the door-opening position (for example, see FIG. 33), it moves the vehicle door opening lever 18 from the standby position to the unlocking position into which the vehicle door 2 can be opened. The movement of the motor-driven positioning member 19 from the resting position via the handle-extension position into the door opening position is a rotational movement around the motor drive axis 51. During the rotational movement of the positioning member 19 from the handle extension position into the door-opening position, the unlocking contour 59 interacts with the longitudinal end 66 of the vehicle door opening lever 18, while the second edge portion 56 of the non-uniform edge 52 with its constant maximum radius 55 holds the lever member 10 in place. By means of the detection means 77, the rotation of the passive lever 27 is detected, whereupon the drive motor is started again and the positioning member 19 continues to rotate counterclockwise (see arrow 58 in FIG. 33). This rotation corresponds to a door unlocking rotational movement of the motor-driven positioning member 19 from the handle-extension position into the door-opening position, in which the second contour portion 62 and then the third contour portion 64 of the unlocking contour 59 press against the longitudinal end 66 of the vehicle door opening lever 18 and urge the vehicle door opening lever 18 from its standby position into its unlocking position to open the vehicle door 2, as shown in FIG. 34. The door-unlocking rotational movement then stops just before the third edge portion 57 of the motor-driven positioning member 19 reaches the lever lug 10a of the lever member 10. Before that, however, the door lock 5 is already unlocked, so that a detection of the door lock unlocking can be used to stop the drive motor. The standby position is shown in FIG. 35, whereas FIG. 36 shows the unlocking position of the vehicle door opening lever 18. In the unlocking position, the Bowden cable lever 18b is swivelled around its hinge point 18a so that the movement of the vehicle door opening lever 18 caused by the motor-driven positioning member 19 during normal operation causes a drag movement on a Bowden cable attached thereto, whereby the door lock 5 is unlocked and the vehicle door 2 can be opened. After the servo-actuation by the operator, the handle 4 returns to its actuating position as a result of the holding force of the holding member 33. After opening the vehicle door 2 or after a predetermined period of time or on the basis of a corresponding signal from an electronic vehicle key, the handle 4 is then moved back to its non-use position, wherein for this purpose the positioning member 19 is rotated back to its resting position, so that the handle 4 reaches its non-use position by means of the restoring force of the restoring spring 50.

As mentioned above, the vehicle door opening lever 18 mounted on the handle housing 8 can be moved between the standby position and the unlocking or opening position of vehicle door 2. The movement to the unlocking position for current-operated normal operation of the door handle assembly 3 is described above. However, the vehicle door opening lever 18 can also be moved into the unlocking position in a currentless emergency operation, which is done by the operator actuating the handle 4. This situation is shown in FIGS. 37 to 41. The handle 4 is movably mounted for emergency operation, which can occur in the case of malfunction of the electrical supply of the vehicle 2 or malfunction of the drive motor, whereby the operator can move the handle from the operating position to an opening position, also referred to as an emergency actuating position, for manual opening of the vehicle door. In FIG. 37, the handle is arranged in this emergency actuating position, which is a position in which the handle is extended from the operating position via the servo-opening position out of the outer contour 7 of the vehicle door 2. The description above for normal operation shows that the handle 4 is decoupled from the vehicle door opening lever 18 in its non-use position and in its operating position. In the case of the door handle assembly 3 according to the invention, the handle 4 couples in an emergency operation with the vehicle door opening lever 18 during a movement from the operating position into the emergency actuating position, wherein the handle 4 moves the vehicle door opening lever 18 into the unlocking position, as indicated by arrow 42 in FIG. 34. In particular, the handle 4 couples with the vehicle door opening lever 18 during a movement from the operating position to the emergency actuating position. In emergency operation, during the movement of the handle 4 from the actuating position in the direction of the emergency actuating position, the actuating lug 75 engages in the cam portion 76 and pushes the vehicle door opening lever 18 from the standby position into the unlocking position (see FIG. 39). By pulling the handle 4, the lever mechanism 16 is rotated around the rotational axis 21 by about 7°, wherein this movement takes place against the holding force of the holding member 33 and against the counterforce of the leg spring member 79. The operator must therefore apply a much higher force relative to normal operation to move the handle 4 to the emergency actuating position and rotate the Bowden cable lever 18b to unlock the door lock 5. By overcoming the holding force of the holding element 33, the passive lever 27 is rotated away from the active lever 28 so that the passive lever 27 does not abut on the active lever 28 anymore (see for example FIG. 40). Additionally, the operator must move the handle 4 against the counterforce of the leg spring 79 to push the vehicle door opening lever 18 into the unlocking position. During this movement of the handle 4 in the direction of the emergency actuating position, the second leg 79b of the leg spring member 79 comes into contact with the limit stop lug 81 formed on the handle housing 8, whereby the leg spring member 79 in the emergency actuating position of the handle 4 is compressed to produce the counterforce (see FIG. 41). The actuation of the handle 4 is more difficult than the servo-actuation as a result of the application of the two spring members 33 and 79. The extended position of the passive lever 27 in FIG. 38 also represents a mechanical end stop, because the handle 4 cannot be moved further than into this position. As a result of the spring force of the door lock 5, the vehicle door opening lever 18 is repeatedly moved back via the Bowden cable to its initial position, i.e. to the standby position, when the force of the operator no longer acts on the handle 4.

The emergency operation of door handle assembly 3 described above assumes that the handle 4 is in its actuating position or in a position in which the operator can engage the handle 4 for actuation. If the handle 4 is in its non-use position and a currentless emergency operation is given, the invention provides for the door handle assembly 3 that in the case of a malfunction of the motor-driven positioning member 19, the handle 4 can be moved by the operator into an emergency handling position shown in FIG. 43. In the emergency handling position, the first longitudinal end 9 of the handle 4 is moved towards the handle housing 8 with respect to the non-use position and the second longitudinal end 20 of the handle 4 is moved away from the handle housing 8. The holding element 33 allows a movement of the first longitudinal end 9 of the handle 4 in the direction of the handle housing 8 and relative to the second lever end 14 of the lever element 10 and a movement of the second longitudinal end 20 of the handle 4 away from the handle housing 8 against the holding force exerted by the holding element 3. This is possible because the binding of the second longitudinal end 20 of the handle 4 is effected via the lever mechanism 16, which is designed in the manner of a toggle lever and in which the passive lever 27 and the active lever 28 are held in a stable and abutting position by the holding force of the holding member 33. The first end 29 of the passive lever 27 is connected to the rotational axis 21 in a torque-proof manner, while the first end 30 of the active lever 28 is rotatably connected to the rotational axis 21. As described above, in the non-use position of the handle 4 the holding member 33 presses the abutment portion 34 of the passive lever 27 against the counter abutment portion 35 of the active lever 28. However, in the emergency handling position of the handle 4, a compressive force exerted by the operator and exceeding the holding force of the holding member 33 acts on the first longitudinal end 9 of the handle 4, whereby the abutment portion 34 of the passive lever 27 is arranged to be rotated away from the counter abutment portion 35 of the active lever 28 (for example, see FIGS. 43 and 45, wherein FIG. 44 shows a position of the lever mechanism 16 in which the handle 4 is arranged in its non-use position). During the movement from the non-use position into the emergency handling position, the handle 4 transfers a compressive force exerted by the operator at the first longitudinal end 9 (see arrow 84) via the second longitudinal end 20 to the passive lever 27 of the lever mechanism 16, which causes a relative rotation of the passive lever 27 with respect to the active lever 28, so that in the emergency handling position the abutment portion 34 of the passive lever 27 is arranged in a spaced-apart manner from the counter abutment portion 35 of the active lever 28. To prevent unintentional movement of the handle 4 into the emergency handling position, the holding force of the holding member 33 is dimensioned so that the holding member 33 presses the abutment portion 34 of the passive lever 27 against the counter abutment portion 35 of the active lever 28 up to an acceleration force acting in the case of a vehicle accident or up to a compression force of at least 30 g exerted by the operator. In order to prevent the handle 4 from being pressed indefinitely into the outer contour 7 of the vehicle door 2 while overcoming the holding force, the lever member 10 has a supporting lug 82 between its first lever end 11 and its second lever end 14. The supporting lug 82 is located in the emergency handling position on a movement limiting lug 83 formed on the handle 4 and limiting the movement of the handle 4 towards the handle housing 8, as shown in FIG. 47, wherein FIG. 46 shows the position of the handle 4 in its non-use position. Meaning that in this emergency operation, where the handle 4 is in its non-use position, the handle 4 is pressed into its first longitudinal end 9, whereby the second longitudinal end 20 of the handle 4 is unscrewed via the lever mechanism 16. This allows the operator to grasp the handle 4 and pull it completely out of the outer contour 7 of the vehicle door 2 into the emergency actuating position and actuate it mechanically.

Finally, it should be mentioned that the handle 4 is hinged to the lever system 15, in particular to the lever member 10 and to the handle lever 22, at its first longitudinal end 9 and at its second longitudinal end 20 via corresponding screw means. The handle 4 itself can be replaced by loosening the screw means from a position in which the handle 4 is exposed from the outer contour 7 of the vehicle door 2.

Other preferred embodiments of the present invention are described in the following paragraphs:

An additional preferred embodiment of the invention relates to a door handle assembly 3 for a vehicle door 2 with a handle housing 8, which is fastened to the vehicle door 2, a handle 4 mounted on the handle housing 8, which in a non-use position is arranged to extend flush with an outer contour 7 of the vehicle door 2, and which for actuation by an operator is arranged in an actuating position, in which the handle 4 protrudes relative to the outer contour 7 of the vehicle door 2 and can be actuated by the operator in order to open the vehicle door 2, a lever member 10, whose first lever end 11 is rotatably mounted on a lever rotational axis 12 mounted on the handle housing 8 and whose second lever end 14 is rotatably connected to a first longitudinal end 9 of the handle 4, and a lever mechanism 16, which is rotatably mounted on the handle housing 8 via a rotational axis 21, wherein a second longitudinal end 20 of the handle 4 is movably fastened to the handle housing 8 via the lever mechanism 16, wherein the lever member 10 is of a single-arm and angled configuration, wherein the lever mechanism 16 has a handle lever 22 and a lever body 23 rotatably mounted on the rotational axis 21, wherein the handle lever 22 is single-armed and angled, wherein a first end 24 of the handle lever 22 is rotatably connected to the second longitudinal end 20 of the handle 4 and a second end 25 of the handle lever 22 is rotatably connected to the lever body 23 via a pivot point 26, wherein the lever member 10 is movably coupled to the lever mechanism 16 in a manner that, during a movement of the handle 4 from the non-use position into the actuating position, the lever member 10 rotates around the lever rotational axis 12 and at the same time the lever mechanism 16 rotates around the rotational axis 21, and wherein the lever member 10 moves the first longitudinal end 9 of the handle 4 out of the outer contour 7, when the rotation around the rotational axis 12 of the lever begins, and the lever mechanism 16 moves the second longitudinal end 20 of the handle 4 out of the outer contour 7, when the rotation around the rotational axis 21 begins, only after a dead point 72 of the handle lever 22 has been exceeded.

According to aspects of the additional preferred embodiment, a motor-driven positioning member 19 is mounted on the handle housing 8, which rotates the lever member 10 around the lever rotational axis 12 in a current-operated normal operation of the door handle assembly 3. The lever member 10 is movably coupled to the lever mechanism 16 via a movement transmission bracket 17. Further, the lever body 23 has a supporting member 71, against which the handle lever 22 abuts at least in portions in the non-use position of the handle 4 and during a movement of the handle 4 in the direction of the actuating position until the dead point 72 is exceeded.

According to additional aspects of the additional preferred embodiment, a first longitudinal end 39 of the movement transmission bracket 17 with a lever rotational axis distance 73 to the lever rotational axis 12 is rotatably connected to the lever member 10, and a second longitudinal end 40 of the movement transmission bracket 17 with a lever rotational axis distance 74 to the rotational axis 21 is rotatably connected to the lever mechanism 16. The lever body 23 has a single-armed passive lever 27 and a two-armed active lever 28, wherein a first end 29 of the first passive lever 27 and the active lever 28 are mounted on the rotational axis 21 mounted on the handle housing 8, wherein a first end 24 of the handle lever 22 is rotatably connected to the second longitudinal end 20 of the handle 4, wherein a second end 25 of the handle lever 22 is rotatably connected to a second end 31 of the passive lever 27, wherein a first active lever arm 28a of the active lever 28 is rotatably connected to the second longitudinal end 40 of the movement transmission bracket 17, and the supporting member 71 is formed on a second active lever arm 28b of the active lever 28. The first end 29 of the passive lever 27 is connected to the rotational axis 21 in a torque-proof manner and the first end 30 of the active lever 28 is rotatably connected to the rotational axis 21. The lever mechanism 16 has a holding member 33, wherein the passive lever 27 has an abutment portion 34 and a counter abutment portion 35 is formed on the active lever 28, and wherein the holding member 33 has a holding force pressing the abutment portion 34 of the passive lever 27 against the counter abutment portion 35 of the active lever 28.

According to additional aspects of the additional preferred embodiment, the holding member 33 allows the passive lever 27 to move relative to the active lever 28 against the holding force exerted by the holding member 33 so that the abutment portion 34 of the passive lever 27 is arranged spaced apart from the counter abutment portion 35 of the active lever 28. The holding member 33 is designed as an elastic spring member 36, with a first leg 36a of the spring member 36 engaging in a hook-shaped holding lug 37 formed on the passive lever 27 and a second leg 36b of the spring member 36 engaging in a hook-shaped holding piece 38 formed on the active lever 28. Further, the lever member 10 is of an U-shaped angled form, wherein a handle lever leg 44 ending at the first end 24 of the handle lever 22 is formed with a handle lever length 45 which is at least 1.25 times greater than a lever member length 46 of a lever member leg 47 ending at the second lever end 14 of the lever member 10. During a movement of the handle 4, the second lever end 14 of the lever member 10 is arranged at a constant spacing from the lever rotational axis 12, whereas the first end 24 of the handle lever 22 is arranged at a varying spacing from the rotational axis 21 depending on the movement position of the handle 4.

According to additional aspects of the additional preferred embodiment, the mechanical restoring member 49 pushes the handle 4 into its non-use position and allows a movement of the handle 4 from the non-use position in the direction of the actuating position against a restoring force generated by the mechanical restoring member 49. The mechanical restoring member 49 is formed as a restoring spring 50 which is wound around the lever rotational axis 12, wherein a first spring leg 50a of the restoring spring 50 is supported on the handle housing 8 and a second spring leg 50b of the restoring spring 50 is supported on the lever member 10.

An additional aspect of the additional preferred embodiment is a method of operating a door handle assembly 3 of a vehicle door 2, wherein the door handle assembly 3 has a handle housing 8 fastenable to the vehicle door 2 and a handle 4 mounted on the handle housing 8, which in a non-use position is arranged so as to extend flush with an outer contour 7 of the vehicle door 2 and which, for actuation by an operator, is formed so as to be movable into an actuating position in which the handle 4 protrudes relative to the outer contour 7 of the vehicle door 2 and can be actuated by the operator to open the vehicle door 2, wherein the handle 4 is movably bound to the handle housing 8 with a first longitudinal end 9 via a lever element 10, and wherein the handle 4 is movably bound at a second longitudinal end 20 via a lever mechanism 16 to the handle housing 8, wherein during a movement from the non-use position into the actuating position the first longitudinal end 9 of the handle 4 is extended by the lever member 10 from the outer contour 7 of the vehicle door 2 and the second longitudinal end 20 of the handle 4 is moved out with a time delay by the lever mechanism 16 to the first longitudinal end 9 of the handle 4, wherein the second longitudinal end 20 of the handle 4 is moved out further by the lever mechanism 16 than the first longitudinal end 9 of the handle 4.

An additional preferred embodiment of the invention relates to a door handle assembly 3 for a vehicle door 2 with a handle 4 extending flush in a non-use position with an outer contour 7 of the vehicle door 2 for actuation by an operator, a handle housing 8, which can be fastened to the vehicle door 2, a lever member 10, which mounts the handle 4 on the handle housing 8, whose first lever end 11 is rotatably mounted on a lever rotational axis 12 mounted on the handle housing 8 and whose second lever end 14 is movably coupled to the handle 4, and a motor-driven actuating member 19 is movably coupled to the lever member 10, which is mounted on the handle housing 8 movably between a resting position via a handle-extension position into a door-opening position, wherein, in normal operation of the door handle assembly 3, the motor-driven actuating member 19 during its movement out of the resting position, in which the handle 4 is arranged in the non-use position, moves the handle 4 into the handle-extension position into an actuating position, in which the handle 4 protrudes relative to the outer contour 7 of the vehicle door 2, wherein the handle 4 is formed to be movable out of the actuating position into a servo-opening position by means of actuation by an operator into a servo-opening position, wherein a detection means 77 is arranged on the handle housing 8, which is formed to effect a movement of the motor-driven actuating element 19 from the handle-extension position into a door-opening position upon detection of a movement of the handle 4 from the actuated position into the servo-opening position, wherein the motor-driven actuating element 19 is movably coupled to a vehicle door opening lever 18 movably mounted on the handle housing 8 between a standby position and an unlocking position, and wherein the motor-driven actuating element 19 during its movement from the handle extension position into the door opening position moves the vehicle door opening lever 18 from the standby position into the unlocking position into which the vehicle door 2 can be opened.

According to aspects of the additional preferred embodiment, the motor-driven positioning member 19 is rotatably mounted on the handle housing 8 via a motor drive axis 51, wherein, the movement of the motor-driven positioning member 19 from the resting position via the handle-extension position into the door-opening position is a rotational movement around the motor drive axis 51. The motor-driven positioning member 19 is discoidal with a non-uniform edge 52, which when the positioning member 19 rotates around the motor drive axis 51 from the resting position into the handle extension position, interacts with a lever lug 10a formed on the lever member 10. The non-uniform edge 52 has a first edge portion 53 with a radius increasing from a minimum radius 54 to a maximum radius 55 and a second edge portion 56 with a maximum radius 55, wherein the maximum radius 55 is larger than the minimum radius 54. During a uniform rotational movement of the motor-driven positioning member 19 from the resting position into the handle-extension position, the first edge portion 53 presses with increasing radius against the lever lug 10a of the lever member 10, wherein the handle 4 moves out of the non-use position into the actuating position via the lever member 10.

According to additional aspects of the additional preferred embodiment, the uniform rotational movement of the motor-driven positioning member 19 stops when the second edge portion 56 of the motor-driven positioning member 19 abuts on the lever lug 10a of the lever member 10. The non-uniform edge 52 has a third edge portion 57 with a minimum radius 54, wherein the transition from the second edge portion 56 to the third edge portion 57 is abruptly formed. The lever lug 10a of the lever member 10 abuts on the third edge portion 57 when the handle 4 is in the non-use position and the motor-driven positioning member 19 is in the resting position. An unlocking contour 59 is formed on the upper or lower side of the motor-driven actuating member 19 in the discoidal form, which interacts with the vehicle door opening lever 18 during a movement of the actuating member 19 from the handle-extension position into the door-opening position.

According to additional aspects of the additional preferred embodiment, the unlocking contour 59 has a first contour portion 60 with a constant neutral radius 61, a second contour portion 62 with a progression radius 63 and a third contour portion 64 with a constant radius 65, wherein the constant radius 65 is larger than the neutral radius 61, wherein the constant radius 65 and the neutral radius 61 each have a constant radius, and wherein the progression radius 63 is a radius increasing from the neutral radius 61 to the constant radius 65. During a rotational movement of the motor-driven positioning member 19 from the resting position to the handle-extension position, the first contour portion 62 with neutral radius 61 tangentially moves past a longitudinal end 66 of the vehicle door opening lever 18. During a door unlocking rotational movement of the motor-driven positioning member 19 from the handle-extension position into the door-opening position, the second contour portion 62 and then the third contour portion 64 of the unlocking contour 59 press against the longitudinal end 66 of the vehicle door opening lever 18 and urge the vehicle door opening lever 18 from its standby position into its unlocking position for opening the vehicle door 2. The door-unlocking rotational movement stops when the second edge portion 56 of the motor-driven positioning member 19 abuts on the lever lug 10a of the lever member 10. The constant radius 65 of the unlocking contour 59 is smaller than the maximum radius 55 of the non-uniform edge 52 of the motor-driven positioning member 19. Further, a curved disk in addition to and separately from the motor-driven positioning member 19 is rotatably mounted on the handle housing 8 via the motor drive axis 51, wherein the curved disc interacts with the vehicle door opening lever 18 to move the vehicle door opening lever 18 from the standby position to the unlocking position.

Another preferred embodiment of the invention relates to a door handle assembly 3 for a vehicle door 2 with a handle housing 8 which can be fastened to the vehicle door 2, a handle 4 which is mounted on the handle housing 8 and which, in a non-use position, is arranged to extend flush with an outer contour 7 of the vehicle door 2 and which, for actuation by an operator, is arranged in an actuating position, in which the handle 4 protrudes relative to the outer contour 7 of the vehicle door 2 and can be actuated by the operator to open the vehicle door 2, a lever member 10, whose first lever end 11 is rotatably mounted on a lever rotational axis 12 mounted on the handle housing 8 and whose second lever end 14 is rotatably connected to a first longitudinal end 9 of the handle 4, and a motor-driven positioning member 19 which rotates the lever member 10 around the lever rotational axis 12 and thereby moves the handle 4 from the non-use position into the actuating position, wherein a lever mechanism 16 is rotatably mounted on the handle housing 8 via a rotational axis 21, and wherein a second longitudinal end 20 of the handle 4 is movably fastened to the handle housing 8 via the lever mechanism 16.

According to aspects of the other preferred embodiment, a mechanical restoring element 49 pushes the handle 4 into its non-use position, allowing the movement of the handle 4 from the non-use position towards the actuating position against a restoring force generated by the mechanical restoring member 49. The mechanical restoring member 49 is formed as a restoring spring 50 which is wound around the lever rotational axis 12, wherein a first spring leg 50a of the restoring spring 50 is supported on the handle housing 8 and a second spring leg 50b of the restoring spring 50 is supported on the lever member 10. The lever member 10 is movably coupled to the lever mechanism 16 via a movement transmission bracket 17. A first longitudinal end 39 of the movement transmission bracket 17 is rotatably connected to the lever member 10 at a distance from the lever rotational axis 12, wherein a second longitudinal end 40 of the movement transmission bracket 17 is rotatably connected to the lever mechanism 16 at a distance from the rotational axis 21.

According to additional aspects of the other preferred embodiment, the lever mechanism 16 comprises a passive lever 27, an active lever 28 and a handle lever 22, wherein a first end 29 of the first passive lever 27 and a first end 30 of the active lever 28 are mounted on the rotational axis 21 mounted on the handle housing 8, wherein a first end 24 of the handle lever 22 is rotatably connected to the second longitudinal end 20 of the handle 4, wherein a second end 25 of the handle lever 22 is rotatably connected to a second end 31 of the passive lever 27, and wherein a connecting web 32 protrudes radially from the first end 30 of the active lever 28 and is rotatably connected to the second longitudinal end 40 of the movement transmission bracket 17. The first end 29 of the passive lever 27 is connected to the rotational axis 21 in a torque-proof manner, while the first end 30 of the active lever 28 is rotatably connected to the rotational axis 21. The lever mechanism 16 has a holding member 33, wherein the passive lever 27 has an abutment portion 34 and a counter abutment portion 35 is formed on the active lever 28, and wherein the holding member 33 has a holding force pressing the abutment portion 34 of the passive lever 27 against the counter abutment portion 35 of the active lever 28. The holding member 33 allows a movement of the passive lever 27 relative to the active lever 28 against the holding force exerted by the holding member 33, so that the abutment portion 34 of the passive lever 27 is spaced apart from the counter abutment portion 35 of the active lever 28.

According to additional aspects of the other preferred embodiment, the holding member 33 is formed as an elastic spring member 36, wherein a first leg 36a of the spring member 36 engages in a hook-shaped holding lug 37 formed on the passive lever 27 and a second leg 36b of the spring member 36 engages in a hook-shaped holding piece 38 formed on the active lever 28. The spring member 36 is arranged wound around the rotational axis 21. In the actuating position of the handle 4, the motor-driven positioning member 19 presses the second longitudinal end 40 of the movement transmission lever 17 at least in portions against a arresting stop 67 fastened to the handle housing 8. Further, in the actuating position of the handle 4, the motor-driven positioning member 19 presses a support lug 68 formed on the lever member 10 at least in portions against a support stop 69 formed on the handle housing 8.

Another preferred embodiment of the invention relates to a door handle assembly 3 for a vehicle door 2 with a handle housing 8 attachable to the vehicle door 2, a handle 4 mounted on the handle housing 8, which in a non-use position is arranged to extend flush with an outer contour 7 of the vehicle door 2 and which for actuation by an operator is arranged in an actuating position, in which the handle 4 protrudes relative to the outer contour 7 of the vehicle door 2, a lever member 10, whose first lever end 11 is rotatably mounted on a lever rotational axis 12 mounted on the handle housing 8 and whose second lever end 14 is movably coupled to a first longitudinal end 9 of the handle 4, a motor-driven actuating element 19, which in normal operation of the door handle assembly 3 rotates the lever member 10 around the lever rotational axis 12 and thereby moves the handle 4 from the non-use position into the actuating position, and a lever mechanism 16, which movably mounts a second longitudinal end 20 of the handle 4 on the handle housing 8, wherein the first longitudinal end 9 of the handle 4 is rotatably mounted on the second lever end 14 of the lever element 10, wherein in an emergency operation of the door handle assembly 3 the handle 4 can be moved by the operator into an emergency handling position in the event of malfunction of the motor-driven actuating element 19, in which, with respect to the non-use position, the first longitudinal end 9 of the handle 4 is arranged to move towards the handle housing 8 and the second longitudinal end 20 of the handle 4 is arranged to move away from the handle housing 8, and wherein the lever mechanism 16 has a holding member 33, which allows a movement of the first longitudinal end 9 of the handle 4 towards the handle housing 8 and relative to the second lever end 14 of the lever member 10 and a movement of the second longitudinal end 20 of the handle 4 away from the handle housing 8 against a holding force exerted by the holding member 33.

According to aspects of the other preferred embodiment, the lever mechanism 16 comprises a passive lever 27, an active lever 28 coupled to the motor-driven actuator 19 and a handle lever 22, whereby a first end 29 of the first passive lever 27 and a first end 30 of the active lever 28 are mounted on a rotational axis 21 mounted on the handle housing 8, wherein a first end 24 of the handle lever 2 is rotatably connected to the second longitudinal end 20 of the handle 4 and a second end 25 of the handle lever 22 is rotatably connected to a second end 31 of the passive lever 27. The first end 29 of the passive lever 27 is connected to the rotational axis 21 in a torque-proof manner and the first end 30 of the active lever 28 is connected to the rotational axis 21 in a rotatable manner. The passive lever 27 comprises an abutment portion 34, the active lever 28 having a counter abutment portion 35 formed thereon, the holding member 33 pressing the abutment portion 34 of the passive lever 27 against the counter abutment portion 35 of the active lever 28 in the non-use position of the handle 4.

According to other aspects of another preferred embodiment, in the emergency handling position of handle 4, a pressure force exerted by an operator and exceeding the holding force of the holding member 33 acts on the first longitudinal end 9 of handle 4, whereby the abutment portion 34 of the passive lever 27 is arranged rotated away from the counter abutment portion 35 of the active lever 28. During a movement from the non-use position into the emergency handling position, the handle 4 transmits a compressive force exerted by the operator at the first longitudinal end 9 via the second longitudinal end 20 to the passive lever 27 of the lever mechanism 16, wherein a relative rotation of the passive lever 27 to the active lever 28 causes the abutment portion 34 of the passive lever 27 in the emergency handling position to be arranged spaced-apart from the counter abutment portion 35. The holding force of the holding member 33 is dimensioned such that the holding member 33 presses the abutment portion 34 of the passive lever 27 against the counter abutment portion 35 of the active lever 28 up to an acceleration force acting in the event of a vehicle accident or up to a pressure force of at least 30 g exerted by the operator. The holding element 33 is further constructed as an elastic spring member 36, wherein a first leg 36a of the spring member 36 engages in a hook-shaped holding lug 37 formed on the passive lever 27 and a second leg 36b of the spring member 36 engages in a hook-shaped holding piece 38 formed on the active lever 28.

According to other aspects of the additional preferred embodiment, the elastic spring member 36 is wound around the rotational axis 21. The lever member 10 has a supporting lug 82 between its first lever end 11 and its second lever end 14, which in the emergency handling position rests against a movement limiting lug 83 formed on the handle 4 and limiting the movement of the handle 4 in the direction of the handle housing 8.

Of course, the invention described above is not limited to the described and illustrated embodiment. It is evident that numerous modifications can be made to the embodiment depicted in the drawing, which are obvious to the person skilled in the art according to the intended application, without leaving the scope of the invention. The invention includes everything that is contained in the description and/or depicted in the drawing, including anything that, deviating from the concrete design example, is obvious to the person skilled in the art.

1. Door handle assembly for a vehicle door comprising:
a handle housing attachable to the vehicle door,
a handle which is mounted on the handle housing and, in a non-use position, is arranged to extend flush with an outer contour of the vehicle door and, for actuation by an operator, is formed to be movable into an actuating position in which the handle protrudes relative to the outer contour of the vehicle door, and
a vehicle door opening lever mounted on the handle housing to be movable between a standby position and an unlocking position opening the vehicle door,
wherein the handle is mounted to be movable by the operator from the actuating position into an emergency actuating position for a manual opening of the vehicle door,
wherein the handle is decoupled from the vehicle door opening lever in its non-use position and in its actuating position, and
wherein the handle couples with the vehicle door opening lever during a movement from the actuating position into the emergency actuating position and moves the latter into the unlocking position.

2. Door handle assembly according to claim 1, wherein a lever mechanism rotatably mounts the handle on the handle housing and couples the handle with the vehicle door opening lever during a movement from the actuating position into the emergency actuating position.

3. Door handle assembly according to claim 2, wherein a lever member mounted on the handle housing is connected to a first longitudinal end of the handle, wherein the lever mechanism has a passive lever, whose first end is connected in a torque-proof manner to an rotational axis, which is rotatably mounted on the handle housing, and whose second end is connected to a second longitudinal end of the handle.

4. Door handle assembly according to claim 3, wherein the passive lever has a radially extending actuating lug at its first end and a hook-shaped cam portion is formed on the vehicle door opening lever, wherein when the handle moves out of the actuating position in the direction of the emergency actuating position, the actuating lug engages in the cam portion and urges the vehicle door opening lever out of the standby position into the unlocking position.

5. Door handle assembly according to claim 4, wherein a counterforce member is formed on a portion of the actuating lug which allows a movement of the handle from the actuating position into the emergency actuating position against a counterforce exerted by the counterforce member.

6. Door handle assembly according to claim 5, wherein the counterforce member is formed as an elastic leg spring member, wherein a first leg of the leg spring member is supported on the actuating lug and a second leg of the leg spring member rests on a hook-shaped holding lug.

7. Door handle assembly according to claim 6, wherein the second leg of the leg spring member abuts on a limit stop formed on the handle housing during a movement of the handle from the actuating position in the direction of the emergency actuating position, and the leg spring member is compressed so as to generate the counterforce in the emergency actuating position of the handle.
